(19) United States
(12) Patent Application Publication
(10) Pub. No.: US 2024/0049258 A1
(43) Pub. Date: Feb. 8, 2024

(54) METHOD AND APPARATUS FOR MEASURING AND REPORTING QOE OF APPLICATION FOR MBS BROADCAST SERVICE IN MOBILE COMMUNICATION SYSTEM

(71) Applicant: Samsung Electronics Co., Ltd., Gyeonggi-do (KR)

(72) Inventors: Beomsik BAE, Gyeonggi-do (KR); Seungbeom JEONG, Gyeonggi-do (KR)

(21) Appl. No.: 18/363,317

(22) Filed: Aug. 1, 2023

(30) Foreign Application Priority Data
Aug. 4, 2022 (KR) 10-2022-0097454

(51) Int. Cl. H04W 72/30; H04W 72/54; H04W 76/20

(52) U.S. Cl. CPC H04W 72/30; H04W 72/54; H04W 76/20

(57) ABSTRACT

The disclosure relates to a 5G or 6G communication system for supporting a higher data transmission rate. Specifically, the disclosure suggests a method for measuring and reporting QoE of an application to seamlessly support an MBS broadcast service. Th method includes receiving, from a BS, while the terminal is in an RRC idle state, information on an application layer measurement configuration associated with an MBS broadcast session, wherein the application layer measurement configuration includes a QoE measurement configuration and a QoE report configuration; measuring a QoE for the MBS broadcast session based on the QoE measurement configuration; and transmitting, to the BS, the QoE measurement for the MBS broadcast session based on the QoE report configuration.

### CROSS-REFERENCE TO RELATED APPLICATION(S)

This application is based on and claims priority under 35 U.S.C. § 119 to Korean Patent Application No. 10-2022-0097454, which was filed in the Korean Intellectual Property Office on Aug. 4, 2022, the entire disclosure of which is incorporated herein by reference.

### BACKGROUND

### 1. Field

The disclosure relates generally to a mobile communication system (or wireless communication system, and more particularly, to a method and an apparatus in which a user equipment (UE), a base station (BS), and entities of operation and management (OAM) and a core network (CN) support a multicast and broadcast service (MBS).

### 2. Description of Related Art

5^{th} generation (5G) mobile communication technologies define broad frequency bands for high transmission rates and new services, and can be implemented in “sub 6 GHz” bands such as 3.5 GHz, and in “above 6 GHz” bands, which may be referred to as mmWave, including 28 GHz and 39 GHz. In addition, implementation of 6th (6G) mobile communication technologies (referred to as beyond 5G systems) in terahertz (THz) bands (e.g., 95 GHz to 3 THz bands) has been considered to accomplish transmission rates fifty times faster than 5G mobile communication technologies and ultra-low latencies one-tenth of 5G mobile communication technologies.

Since the initial development of 5G mobile communication technologies, to support services and satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by newer 5G mobile communication technologies, such as physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, a non-terrestrial network (NTN), which is UE-satellite direct communication for providing coverage in an area in which communication with terrestrial networks is unavailable, and positioning.

There has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosure has been made to address at least the above-mentioned problems and/or disadvantages and to provide at least the advantages described below.

An aspect of the disclosure is to provide a method and a procedure for a UE to measure a quality of experience (QoE) with respect to an MBS application and transfer the QoE measurement to a QoE measurement result collection server, via a BS, with regard to an MBS broadcast service in a mobile communication system.

In accordance with an aspect of the disclosure, a method performed by a terminal is provided. The method includes receiving, from a BS, while the terminal is in a radio resource control (RRC) idle state, information on an application layer measurement configuration associated with an MBS broadcast session, wherein the application layer measurement configuration includes a QoE measurement configuration and a QoE report configuration; performing QoE measurement for the MBS broadcast session based on the QoE measurement configuration; and transmitting, to the BS, a result of the QoE measurement for the MBS broadcast session based on the QoE report configuration.

In accordance with another aspect of the disclosure, a terminal is provided. The terminal includes a transceiver; and a controller coupled with the transceiver and configured to receive, from a BS, while the terminal is in an RRC idle state, information on an application layer measurement configuration associated with an MBS broadcast session, wherein the application layer measurement configuration includes a QoE measurement configuration and a QoE report configuration, perform QoE measurement for the MBS broadcast session based on the QoE measurement configuration, and transmit, to the BS, a result of the QoE measurement for the MBS broadcast session based on the QoE report configuration.

In accordance with another aspect of the disclosure, a method performed by a BS is provided. The method includes transmitting, to a terminal in an RRC idle state, information on an application layer measurement configuration associated with an MBS broadcast session, wherein the application layer measurement configuration includes a QoE measurement configuration and a QoE report configuration; and receiving, from the terminal, a result of a QoE measurement for the MBS broadcast session based on the QoE report configuration, wherein the QoE measurement is based on the QoE measurement configuration.

In accordance with another aspect of the disclosure, a BS is provided. The BS includes a transceiver; and a controller coupled with the transceiver and configured to transmit, to a terminal in an RRC idle state, information on an application layer measurement configuration associated with an MBS broadcast session, wherein the application layer measurement configuration includes a QoE measurement configuration and a QoE report configuration, and receive, from the terminal, a result of a QoE measurement for the MBS broadcast session based on the QoE report configuration, wherein the QoE measurement is based on the QoE measurement configuration.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a next generation mobile system structure to which the disclosure may be applied;

FIG. 2 is a signal flow diagram illustrating a QoE measurement control procedure and report procedure in a UE with respect to an MBS broadcast service together with an MBS broadcast session configuration according to an embodiment;

FIG. 3 is a flowchart illustrating a procedure for performing a QoE measurement and report operation with respect to an MBS broadcast session service received by an MBS UE according to an embodiment;

FIG. 4A illustrates a configuration example of a next generation application protocol (NGAP) message related according to an embodiment;

FIG. 4B illustrates an MBS QoE measurement collection (QMC) configuration information according to an embodiment;

FIG. 5 illustrates an F1 application protocol (F1AP) message according to an embodiment;

FIG. 6 illustrates MBS measurement-related configuration information according to an embodiment;

FIG. 7 is a signal flow diagram illustrating a QoE measurement control procedure and report procedure in a UE with respect to an MBS broadcast service together with an MBS broadcast session configuration and a procedure in which a radio access network (RAN) node and a QoE measurement result collection server identify and collect a QoE measurement for each UE according to an embodiment;

FIG. 8 is a flowchart illustrating a procedure for performing a QoE measurement and report operation with respect to an MBS broadcast session service received by an MBS UE according to an embodiment;

FIG. 9 is a flowchart illustrating a procedure in which a RAN node or a gNB-central unit (CU) receives a QoE measurement and report with respect to an MBS broadcast session service according to an embodiment;

FIG. 10A illustrates an NGAP message according to an embodiment;

FIG. 10B illustrates MBS QMC configuration information according to an embodiment;

FIG. 10C illustrates a QoE reference list according to an embodiment;

FIG. 11 illustrates MBS measurement-related configuration information according to an embodiment;

FIG. 12 is a signal flow diagram illustrating a QoE measurement control procedure and report procedure in a UE with respect to an MBS broadcast service together with an MBS broadcast session configuration and a procedure in which a RAN node and a QoE measurement result collection server identify and collect a QoE measurement result for each UE according to an embodiment;

FIG. 13 is a flowchart illustrating a procedure for performing a QoE measurement and report operation with respect to an MBS broadcast session service received by an MBS UE according to embodiment;

FIG. 14 illustrates an F1AP message according to an embodiment;

FIG. 15 illustrates MBS measurement-related configuration information according to an embodiment;

FIG. 16 is a signal flow diagram illustrating a QoE measurement control procedure and report procedure in a UE with respect to an MBS broadcast service together with an MBS broadcast session configuration and a procedure in which a RAN node and a QoE measurement result collection server identify and collect a QoE measurement result for each UE according to an embodiment;

FIG. 17 is a flowchart illustrating a procedure for performing a QoE measurement and report operation with respect to an MBS broadcast session service received by an MBS UE according to an embodiment;

FIG. 18 is a signal flow diagram illustrating a QoE measurement control procedure and report procedure of a UE with respect to an MBS broadcast service together with an MBS broadcast session configuration according to an embodiment;

FIG. 19A illustrates an NGAP message according to an embodiment;

FIG. 19B illustrates MBS QMC activation information according to an embodiment;

FIG. 20 illustrates an NGAP message according to an embodiment;

FIG. 21 illustrates an F1AP message according to an embodiment;

FIG. 22 illustrates MBS measurement-related configuration information according to an embodiment;

FIG. 23 illustrates a UE according to an embodiment; and

FIG. 24 illustrates a BS device according to an embodiment.

### DETAILED DESCRIPTION

Hereinafter, various embodiments of the disclosure will be described in detail with reference to the accompanying drawings. In the drawings, the same or like elements may be designated by the same or like reference numbers. Furthermore, a detailed description of known functions or configurations that may make the subject matter of the disclosure unclear will be omitted.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Furthermore, the size of each element does not completely reflect the actual size.

Advantages and features of the disclosure and ways to achieve them will be apparent by making reference to embodiments as described below in detail in conjunction with the accompanying drawings. However, the disclosure is not limited to the embodiments set forth below, but may be implemented in various different forms.

Each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s).

In some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, a “unit” does not always have a meaning limited to software or hardware. A “unit” may be constructed either to be stored in an addressable storage medium or to execute one or more processors. Therefore, a “unit” includes, e.g., software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, a “unit” may include one or more processors.

In the following description, terms for identifying access nodes, terms referring to network entities, terms referring to messages, terms referring to interfaces between network entities, terms referring to various identification information, etc., are illustratively used for the sake of descriptive convenience.

In the following description of the disclosure, terms and names defined in the 3rd generation partnership project (3GPP) long term evolution (LTE) standards will be used for the sake of descriptive convenience. However, the disclosure is not limited by these terms and names, and may be applied in the same way to systems that conform other standards.

In the following description, a BS is an entity that allocates resources to terminals, and may be at least one of a next generation node B (gNode B or gNB), an evolved node B (eNode B or eNB), a Node B, a wireless access unit, a BS controller, and a node on a network. In the disclosure, the term “eNB” may be interchangeably used with the term “gNB”. That is, a BS described as “eNB” may also indicate “gNB”.

A terminal may include a UE, a mobile station (MS), a cellular phone, a smartphone, a computer, or a multimedia system capable of performing communication functions. Of course, examples of the BS and the terminal are not limited thereto.

In particular, the disclosure may be applied to the 3GPP NR (i.e., 5th generation mobile communication standards). The disclosure may be applied to intelligent services (e.g., smart homes, smart buildings, smart cities, smart cars or connected cars, healthcare, digital education, retail business, security and safety-related services, etc.) on the basis of 5G communication technology and Internet of things (IoT)-related technology.

A wireless communication system is advancing to a broadband wireless communication system for providing high-speed and high-quality packet data services using communication standards, such as high-speed packet access (HSPA) of 3GPP, LTE or evolved universal terrestrial radio access (E-UTRA), LTE-advanced (LTE-A), LTE-Pro, high-rate packet data (HRPD) of 3GPP2, ultra-mobile broadband (UMB), IEEE 802.16e, etc., as well as typical voice-based services.

As an example of a broadband wireless communication system, an LTE system employs an orthogonal frequency division multiplexing (OFDM) scheme in a downlink (DL) and employs a single carrier frequency division multiple access (SC-FDMA) scheme in an uplink (UL). The UL indicates a radio link through which a UE (or an MS) transmits data or control signals to a BS (eNode B), and the DL indicates a radio link through which the BS transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, should freely reflect various requirements of users, service providers, etc., services satisfying various requirements must be supported. The services considered in the 5G communication system includes eMBB communication, mMTC, URLLC, etc.

eMBB aims at providing a data rate higher than that supported by existing LTE, LTE-A, or LTE-Pro. For example, in a 5G communication system, eMBB should provide a peak data rate of 20 Gbps in the DL and a peak data rate of 10 Gbps in the UL for a single BS. Furthermore, the 5G communication system should provide an increased user-perceived data rate to the UE, as well as the maximum data rate. In order to satisfy such requirements, transmission/reception technologies including a further enhanced MIMO transmission technique should be improved. In addition, the data rate for the 5G communication system may be obtained using a frequency bandwidth of more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as IoT in the 5G communication system. mMTC has requirements, such as support of connection of a large number of UEs in a cell, enhancement coverage of UEs, improved battery time, a reduction in the cost of a UE, etc., in order to effectively provide the IoT. Since IoT provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. A UE supporting mMTC should be configured to be inexpensive, and may require a very long battery life-time such as 10 to 15 years because it is difficult to frequently replace the battery of the UE.

URLLC, which is a cellular-based mission-critical wireless communication service, may be used for remote control for robots or machines, industrial automation, unmanned aerial vehicles, remote health care, emergency alert, etc. Thus, URLLC should provide communication with ultra-low latency and ultra-high reliability. For example, a service supporting URLLC should satisfy an air interface latency of less than 0.5 ms, and also requires a packet error rate of 10-5 or less. Therefore, for the services supporting URLLC, a 5G system should provide a transmit time interval (TTI) shorter than those of other services, and also may require a design for assigning a large number of resources in a frequency band in order to secure reliability of a communication link.

Additionally, eMBB, URLLC, and mMTC may be multiplexed and transmitted in a single system. In order to satisfy different requirements of the respective services, different transmission/reception techniques and transmission/reception parameters may be used between the services. However, mMTC, URLLC, and eMBB are merely examples of different types of services, and service types to which the disclosure is applied are not limited to the above examples.

Furthermore, in the following description, LTE, LTE-A, LTE Pro, 5G (or NR), or 6G systems will be described by way of example, but the embodiments of the disclosure may also be applied to other communication systems having similar technical backgrounds or channel types. In addition, based on determinations by those skilled in the art, the embodiments of the disclosure may also be applied to other communication systems through some modifications without significantly departing from the scope of the disclosure.

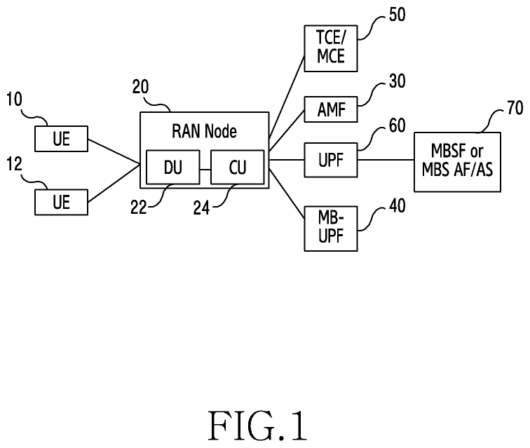

FIG. 1 illustrates a next generation mobile system structure to which the disclosure may be applied.

Referring to FIG. 1, a RAN node 20 may correspond to a mobile communication BS connected to a CN such as 5G CN (5GC). For example, the RAN node 20 may include an LTE eNB, an NR gNB, etc.

A UE 10 or 12 may be connected to a BS (RAN node) 20 through a radio interface (e.g., a Uu interface) and may transmit or receive a control plane signal (e.g., an RRC signal) and user plane data (e.g., an internet protocol (IP) packet). The UE 10 or 12 may receive data (e.g., an MBS broadcast IP packet) for an MBS broadcast service through the radio interface from the RAN node 20.

The RAN node 20 may be connected to the CN through an interface like next generation (NG) and may be connected another RAN node (not shown) through an interface like Xn. The RAN node 20 may include a CU 24 and a distributed unit (DU) 22. The RAN node 20 may include one CU 24 and one or more DUs 22 connected thereto or another combination. The CU 24 and the DU 22 may separately support each function of the RAN node. For example, the CU 24 may support an RRC layer and a packet data convergence protocol (PDCP) layer, and the DU 22 may support a radio link control (RLC) layer, a medium access control (MAC) layer, and a physical (PHY) layer. An interface such as a F1 or W1 interface between internal functions of the RAN node may be connected between the CU 24 and the DU 22. Each DU 22 may be separately configured as a part for supporting RLC/MAC/High-PHY layers and a part for supporting Low-PHY/radio frequency (RF) layers.

An access and mobility management function (AMF) 30 may be connected to the RAN node 20 through a next generation interface (or N2 interface) and transmit or receive a control signal to or from the RAN node 20. A multicast/broadcast-user plane function (MB-UPF) 40 delivers a packet for an MBS service. A trace collection entity/measurement collection entity (TCE/MCE) 50 collects QoE and other information collected by the UE, information measured by the RAN node 20, etc.

A UPF transmits and/or receives user data through the RAN node 20. A multicast/broadcast service function (MBSF) or an MBS application function (AF)/application server (AS) 70 performs a function of delivering and configuring information related to an MBS service through data communication with the UE.

In addition, the CN may include functions and entities such as a session management function (SMF), a multicast/broadcast session management function (MB-SMF), a policy control function (PCF), a unified data management (UDM), and an authentication server function (AUSF).

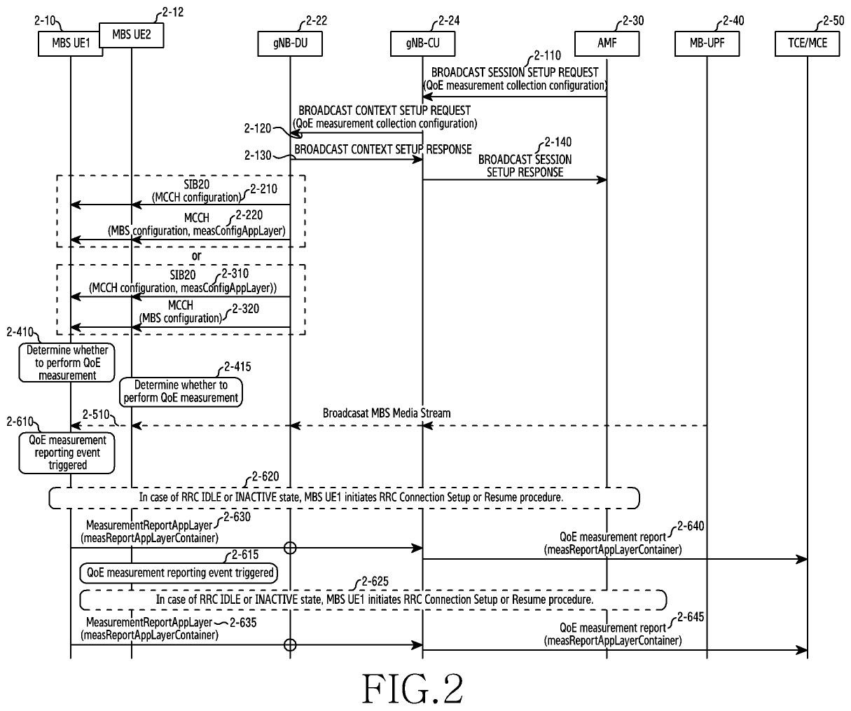

FIG. 2 is a signal flow diagram illustrating a QoE measurement control procedure and report procedure in a UE with respect to an MBS broadcast service together with an MBS broadcast session configuration according to an embodiment.

Referring to FIG. 2, in case that MBS broadcast session connection is started in the CN, the AMF 300 transfers QMC configuration information together with MBS broadcast session configuration information while transmitting a BROADCAST SESSION SETUP REQUEST message to the gNB-CU 24 in step 2-110. The gNB-CU 2-24 in FIG. 2 may correspond to an entity that may perform at least a portion of functions of the RAN node 20 as described above with reference to FIG. 1.

In step 2-120, the gNB-CU 2-24 transfers QMC configuration information together with configuration information for each MBS broadcast session and other information for an MBS broadcast service while transmitting a BROADCAST CONTEXT SETUP REQUEST message to the gNB-DU 2-22. The gNB-DU 2-22 in FIG. 2 may correspond to an entity that may perform at least a portion of functions of the RAN node 20 as described above with reference to FIG. 1.

In response to the BROADCAST CONTEXT SETUP REQUEST, the gNB-DU 2-22 transmits a BROADCAST CONTEXT SETUP RESPONSE message to the gNB-CU 2-24 in step 2-130 as a response.

In step 2-140, the gNB-CU 2-24 transmits a BROADCAST SESSION SETUP RESPONSE message to the AMF 2-30 in response to the BROADCAST CONTEXT SETUP RESPONSE, to inform that the corresponding MBS broadcast session configuration is completed.

After transmitting the BROADCAST CONTEXT SETUP RESPONSE message in step 2-130, the gNB-DU 2-22 generates and transmits information to the MBS UE 2-10 and/or 12 through a system information block (SIB) (e.g., SIB20) or on an MBS control channel (MCCH), based on the MBS broadcast session information, the QMC configuration information, etc., received from the gNB-CU 2-24.

More specifically, the gNB-DU 2-22 transfers configuration information for the MBS UE 2-10 or 2-12 to receive the MCCH by using the SIB message in step 2-210 or 2-310, and transfers configuration information for receiving the MBS service on the MCCH in step 2-220 or 2-320. The MBS UE 2-10 or 2-12 may receive measConfigAppLayer information including the QoE measurement and report configuration information on the MCCH in step 2-220 or may receive measConfigAppLayer information including the QoE measurement and report configuration information through the SIB message in step 2-310.

After the MBS UE 2-10 or 2-12 receives measConfigAppLayer information including the QoE measurement and report configuration information from the RAN node gNB-DU 2-22, the MBS UE 2-10 or 2-12 identifies whether the QoE measurement and report configuration information corresponds to an MBS broadcast session that is being received or to be received. That is, the MBS UE 2-10 or 2-12 determines whether to perform QoE measurement for the MBS broadcast session in step 2-410 or 2-415, respectively.

The MBS UE 2-10 or 2-12 starts to receive MBS packets for the corresponding MBS broadcast session in step 2-510.

Thereafter, in case that the QoE measurement and report function with respect to an MBS broadcast service is supported in step 2-410 or 2-415, the MBS UE 2-10 or 2-12 determines performance of the QoE measurement and report function with respect to the corresponding MBS broadcast service and starts the QoE measurement and measurement information storing in a corresponding MBS broadcast session application.

Thereafter, in step 2-610, a QoE measurement reporting event is triggered for the MBS UE 2-10.

In step 2-620, the MBS UE 2-10 performs conversion (or transition) to an RRC connected state (based on the QoE report configuration information received in step 2-220 or 2-310, and transfers QoE measurement storage information in an application for the MBS broadcast session service being received, to the gNB-CU 2-24, through the gNB-DU 2-22, by using the RRC message in step 2-630. If the MBS UE 2-10 is in the RRC connected state already, step 2-620 may be omitted.

The gNB-CU 2-24 having received the QoE measurement information of the MBS broadcast session service application from the MBS UE 2-10 identifies the TCE/MCE 2-50, based on TCE/MCE information (e.g., a TCE/MCE ID or IP address) included in the QoE measurement information of the MBS broadcast session service application transmitted by the MBS UE 2-10 or the TCE/MCE information (e.g., a TCE/MCE ID or IP address) received from the AMF in step 2-110, and in step 2-640, the gNB-CU 2-24 transfers the QoE measurement information of the MBS broadcast session service application to the TCE/MCE 2-50.

In step 2-615, a QoE measurement reporting event is triggered for the MBS UE 2-12.

In step 2-625, the MBS UE 2-12 performs conversion (or transition) to an RRC connected state, based on the QoE report configuration information received in step 2-220 or 2-310, and transfers QoE measurement storage information in an application for the MBS broadcast session service being received to the gNB-CU 2-24 through the gNB-DU 2-22 by using the RRC message in step 2-635. If the MBS UE 12 is in the RRC connected state already, step 2-625 may be omitted.

The gNB-CU 2-24 having received the QoE measurement information of the MBS broadcast session service application from the MBS UE 2-12 identifies the TCE/MCE 2-50, based on TCE/MCE information (e.g., a TCE/MCE ID or IP address) included in the QoE measurement information of the MBS broadcast session service application transmitted by the MBS UE 2-12 or the TCE/MCE information (e.g., a TCE/MCE ID or IP address) received from the AMF in step 2-110, and in step 2-645, the gNB-CU 2-24 transfers the QoE measurement information of the MBS broadcast session service application to the TCE/MCE 2-50.

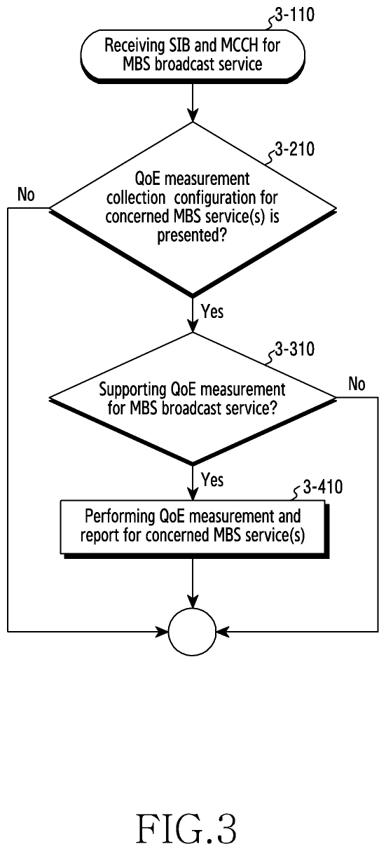

FIG. 3 is a flowchart illustrating a procedure for performing a QoE measurement and report operation with respect to an MBS broadcast session service received by an MBS UE according to an embodiment.

Referring to FIG. 3, in step 3-110, the MBS UE receives configuration information for MBS service reception through an SIB and an MCCH message to receive an MBS broadcast service.

In step 3-210, the MBS UE identifies whether the configuration information transferred through the SIB and the MCCH includes QoE measurement and report configuration information with respect to the MBS broadcast session. For example, the MBS UE determines whether QoE measurement and report configuration information with respect to the MBS broadcast session related to the MBS service provided to the MBS UE exists in the configuration information received in advance.

If the QoE measurement and report configuration information is not included in step 3-210, the MBS UE may receive MBS broadcast service traffic without performing a QoE measurement procedure.

If QoE measurement and report configuration information with respect to the MBS broadcast session is included in information transferred through the SIB or MCCH in step 3-210, the MBS UE determines whether a QoE measurement and report function with respect to an MBS broadcast service is supported in step 3-310.

If the QoE measurement and report function with respect to the MBS broadcast service is not supported in step 3-310, the MBS UE may receive MBS broadcast service traffic without performing a QoE measurement procedure.

If the QoE measurement and report configuration information with respect to the MBS broadcast session is supported in step 3-310, the MBS UE performs QoE measurement and reporting for the MBS service in step 3-410. That is, the MBS UE receives MBS broadcast service traffic while performing QoE measurement and measurement data storing with respect to the corresponding MBS broadcast session in an MBS broadcast service application and transfers the collected QoE measurement information to an RAN node or a gNB-CU according to a QoE measurement report condition based on the configuration information.

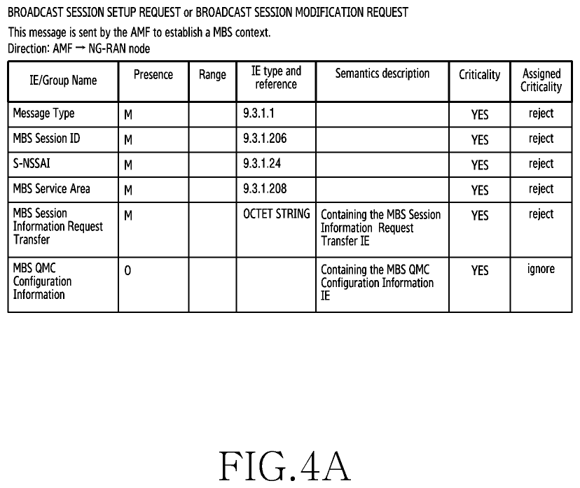

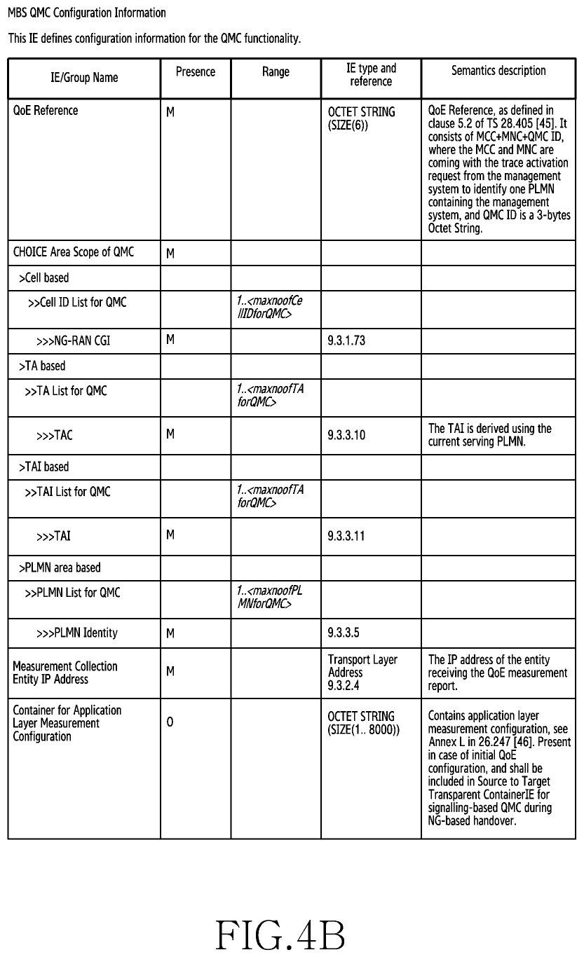

FIG. 4A illustrates an NGAP message according to an embodiment.

Referring to FIG. 4A, the NGAP message may be used for transferring the QMC configuration information together with the MBS broadcast session configuration information by an AMF, e.g., as described in step 2-110 of FIG. 2. In addition, this NGAP message may include a BROADCAST SESSION SETUP REQUEST message or a BROADCAST SESSION MODIFICATION REQUEST message.

The BROADCAST SESSION SETUP REQUEST message or the BROADCAST SESSION MODIFICATION REQUEST message may include information related to the MBS broadcast session configuration, for example, at least one piece of an MBS session identifier (ID), an MBS service area, and MBS session information, together with QMC configuration information with respect to the corresponding MBS session (i.e., MBS QMC configuration information).

FIG. 4B illustrates MBS QMC configuration information according to an embodiment.

Referring to FIG. 4B, the MBS QMC configuration information may include at least one of QoE reference information used for identifying a QoE measurement result, area information (area scope) for QoE measurement, an MCE IP address information, and application layer measurement configuration information (e.g., QoE measurement parameter and condition configuration in an application, and QoE measurement report configuration information). The MBS QMC configuration information may further include other information for the QoE measurement configuration and report configuration with respect to the MBS broadcast service such as MCE ID information in addition to the information described above.

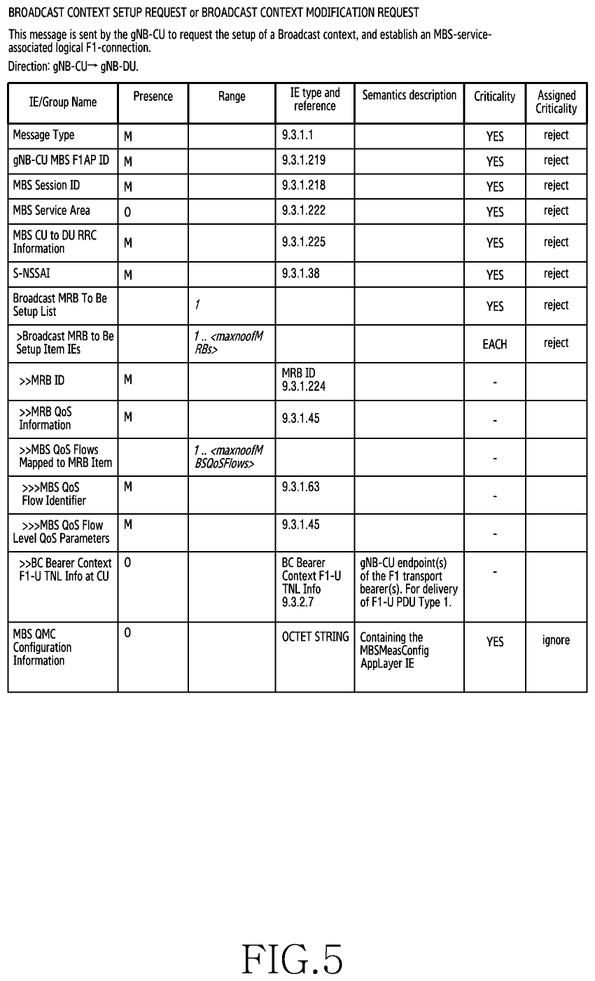

FIG. 5 illustrates an F1AP message according to an embodiment.

Referring to FIG. 5, the F1AP message may be used for transferring the QMC configuration information together with the MBS broadcast session configuration information by a gNB-CU to a gNB-DU, e.g., as in step 2-120 in FIG. 2. The F1AP message shown in FIG. 5 may include a BROADCAST CONTEXT SETUP REQUEST message or a BROADCAST CONTEXT MODIFICATION REQUEST message.

The BROADCAST CONTEXT SETUP REQUEST message or the BROADCAST CONTEXT MODIFICATION REQUEST message may include information related to the MBS broadcast session configuration, e.g., at least one piece of an MBS session ID, an MBS DRB ID, and QoS flow information, together with QMC configuration information with respect to the corresponding MBS session (MBS QMC configuration information). The MBS QMC configuration information in FIG. 5 may include information (e.g., MBSMeasConfigAppLayer information) to be transferred to the MBS UEs through an SIB or MCCH message.

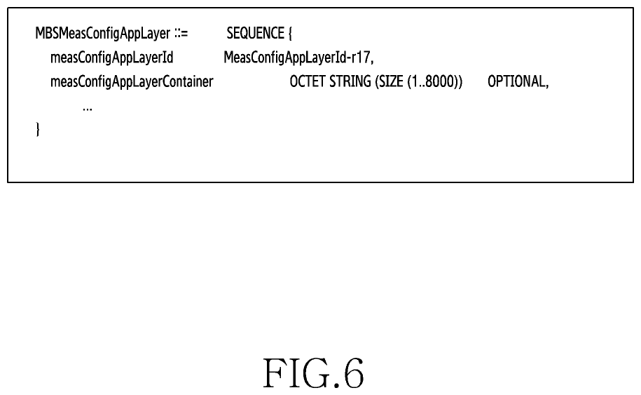

FIG. 6 illustrates MBS measurement-related configuration information according to an embodiment.

Referring to FIG. 6, the MBS measurement-related configuration information may correspond to the information transmitted to transfer QMC configuration information with respect to an MBS session by a gNB-CU to a gNB-DU, e.g., as in step 2-120 in FIG. 2. Alternatively, the MBS measurement-related configuration information in FIG. 6 may be an example of an information element (IE) or an RRC message for transferring the QMC configuration information with respect to the corresponding MBS broadcast to the MBS UEs while included in an SIB message or an MCCH message.

FIG. 6 illustrates an example in which the MBS measurement-related configuration information is realized in an IE (e.g., MBSMeasConfigAppLayer) included in the RRC message. The MBSMeasConfigAppLayer IE may include at least one of measConfigAppLayerId information used by the RAN node 20 or the gNB-CU 22 to identify a QoE measurement result and measConfigAppLayerContainer information including QMC configuration information, and the measConfigAppLayerContainer information may include at least one of area information (area scope) for QoE measurement, an MCE information, application layer measurement configuration information (e.g., QoE measurement parameter and condition configuration in an application, and QoE measurement report configuration information), and other information.

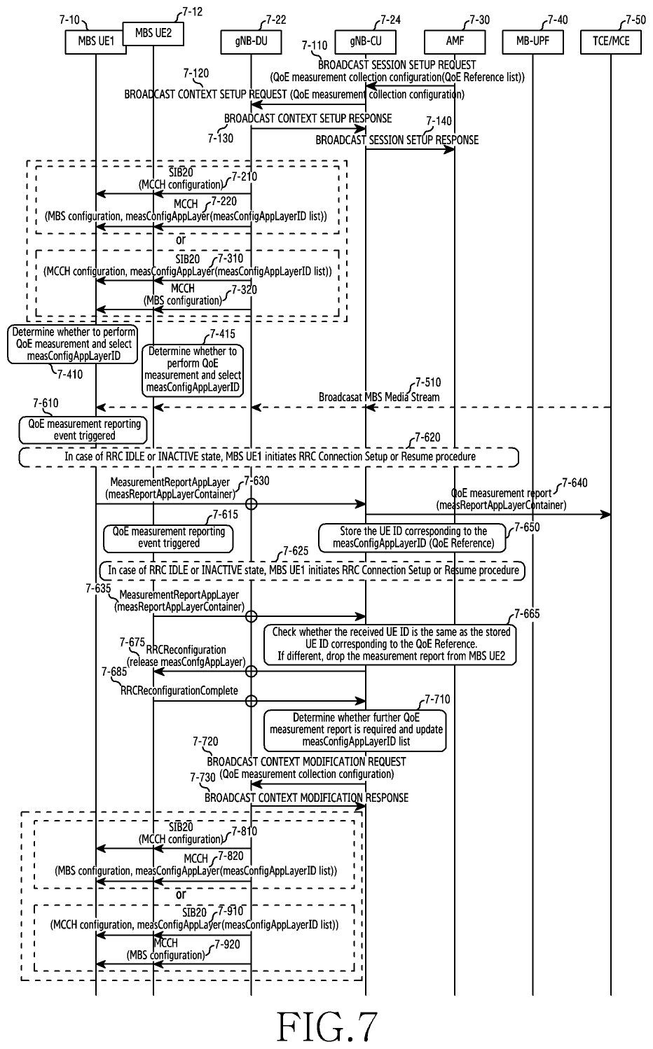

FIG. 7 is a signal flow diagram illustrating a QoE measurement control procedure and report procedure in a UE with respect to an MBS broadcast service together with an MBS broadcast session configuration and a procedure in which a RAN node and a QoE measurement result collection server identify and collect a QoE measurement result for each UE according to an embodiment. More specifically, FIG. 7 is a signal flow diagram illustrating a procedure in which, among UEs supporting QoE measurement/report function with respect to an MBS broadcast service, UEs for receiving the corresponding MBS broadcast service receive common QoE measurement/report configuration information and report a measurement result, and a RAN node identifies a QoE measurement report content for each UE and transfer same to the TCE/MCE server.

Referring to FIG. 7, MBS broadcast session connection is started in the CN and an AMF 7-30 transmits a BROADCAST SESSION SETUP REQUEST message to the RAN node gNB-CU 7-24 in step 7-110. The AMF 7-30 may transfer QMC configuration information together with the MBS broadcast session configuration information to the gNB-CU 7-24. The QMC configuration information transferred from the AMF 7-30 to the gNB-CU 7-24 may include one or more values of a QoE reference that is used for identifying and reporting a QoE measurement result for each UE.

The gNB-CU 7-24 transmits a BROADCAST CONTEXT SETUP REQUEST message to the gNB-DU 7-22 in step 7-120, and the BROADCAST CONTEXT SETUP REQUEST message may include QMC configuration information and other information for the MBS broadcast service in addition to the MBS broadcast session configuration information. The QMC configuration information transferred from the gNB-CU 7-24 to the gNB-DU 7-22 may include one or more measConfigAppLayerId which is used as an identifier for the MBS UE 7-10 or 7-12 to identify a QoE measurement result while collecting MBS broadcast service QoE measurement information data.

The gNB-DU 7-22 transmits a BROADCAST CONTEXT SETUP RESPONSE message to the gNB-CU 7-24 in step 7-130 and the gNB-CU 7-24 transmits a BROADCAST SESSION SETUP RESPONSE message to the AMF 7-30 to inform that the corresponding MBS broadcast session configuration is completed in step 7-140.

The gNB-DU 7-22 generates and transfers information to be transmitted to the MBS UE 7-10 and/or 7-12 through an SIB (e.g., SIB20), based on the MBS broadcast session information, the QMC configuration information, and the like received from the gNB-CU 7-24. Alternatively, the gNB-DU 22 generates and transfers information to be transferred to the MBS UE 7-10 or 7-12 on an MCCH, based on the MBS broadcast session information, the QMC configuration information, and the like received from the gNB-CU 7-24.

In step 7-210 or 7-310, the gNB-DU 7-22 transfers information used for receiving the MCCH to the MBS UE 7-10 or 7-12 by using the SIB message, and in step 7-220 or 7-320, the gNB-DU 7-22 transfers configuration information used for receiving the MBS service to the MBS UE 7-10 or 7-12 on the MCCH. The gNB-DU 7-22 may transmit measConfigAppLayer information including the QoE measurement and report configuration information to the MBS UE 7-10 or 7-12 on the MCCH in step 7-220, or transmit measConfigAppLayer information including the QoE measurement and report configuration information to the MBS UE 7-10 or 7-12 through the SIB message in step 7-310. The measConfigAppLayer may include one or more measConfigAppLayerId to be used as an identifier for identifying the QoE measurement result.

When receiving measConfigAppLayer information including the QoE measurement and report configuration information from the RAN node gNB-DU 7-22, the MBS UE 7-10 or 7-12 identifies whether the QoE measurement and report configuration information is included in the measConfigAppLayer information with respect to the MBS broadcast session which the MBS UE 7-10 or 7-12 is receiving or to receive. Furthermore, in case that the MBS UE 7-10 or 7-12 supports the QoE measurement and report function with respect to an MBS broadcast service, the MBS UE 7-10 or 7-12 determines to perform the QoE measurement and report with respect to an MBS broadcast service in steps 7-410 and 7-415, the MBS UE 7-10 or 7-12 selects one in a measConfigAppLayerId list included in the measConfigAppLayer information and uses same in a QoE measurement result collection procedure and starts QoE measurement and measurement information storing in an application of the corresponding MBS broadcast session.

The MBS UE 7-10 or 7-12 starts to receive an MBS packet for the corresponding MBS broadcast session in step 7-510.

When the MBS UE 7-10 determines that an event (e.g., a periodic report configuration) for reporting the QoE measurement result occurs, based on the QoE report configuration information received from the gNB-DU 7-22 in step 7-610, the MBS UE 7-10 is converted (or transitioned) to an RRC connected state in step 7-620. The MBS UE 7-10 transfers QoE measurement storage information in an application with respect to the MBS broadcast session service which is being received to the gNB-CU 7-24 through the gNB-DU 7-22 by using the RRC message in step 7-630. If the MBS UE 7-10 is in the RRC connected state already, step 7-620 may be omitted.

The gNB-CU 7-24 having received the QoE measurement information of the MBS broadcast session service application from the MBS UE 7-10 stores, in case that the received QoE measurement information is a QoE measurement report firstly reported with respect to the corresponding measConfigAppLayerID from the MBS UE 7-10, a UE ID of the corresponding UE and QoE reference information associated with measConfigAppLayerID and continuously manages the stored information until the corresponding MBS broadcast session service is terminated in step 7-650.

The gNB-CU 7-24 identifies the TCE/MCE 7-50, based on TCE/MCE information (e.g., a TCE/MCE ID or IP address) included in the QoE measurement information of the MBS broadcast session service application transmitted by the MBS UE 7-10 or the TCE/MCE information (e.g., a TCE/MCE ID or IP address) received from the AMF 7-30, and transfers the QoE measurement information of the MBS broadcast session service application to the TCE/MCE 7-50 in step 7-640.

When the MBS UE 7-12 determines that an event (e.g., a periodic report configuration) for reporting the QoE measurement result occurs in step 7-615, based on the QoE report configuration information received from the gNB-DU 7-22, the MBS UE 7-12 is converted (or transitioned) to an RRC connected state in step 7-625. The MBS UE 7-12 transfers QoE measurement storage information in an application with respect to the MBS broadcast session service which is being received to the gNB-CU 7-24 through the gNB-DU 7-22 by using the RRC message in step 7-635. If the MBS UE 7-20 is in the RRC connected state already, step 7-625 may be omitted.

The gNB-CU 7-24 having received the QoE measurement information of the MBS broadcast session service application from the MBS UE 7-20 delete or drop, in case that the received QoE measurement information is not a QoE measurement report firstly reported with respect to the corresponding measConfigAppLayerID from the MBS UE 7-12, the QoE measurement report reported from the MBS UE 7-12 in step 7-665. The gNB-CU 7-24 indicates the MBS UE 7-12 to release the QoE measurement and report in the corresponding MBS broadcast session service application by using an RRC connection reconfiguration (e.g., RRCReconfiguration) message in step 7-675, and the MBS UE 7-12 transmits an RRC connection reconfiguration complete (e.g., RRCReconfigurationComplete) message to the gNB-CU 7-24 as a response in step 7-685.

The RAN node 7-20 or the gNB-CU 7-24 determines whether additional QoE measurement report is required and determine to update a measConfigAppLayerID list in step 7-710. Specifically, the RAN node 7-20 or the gNB-CU 7-24 may determine to delete measConfigAppLayerID of which a QoE measurement result has been reported already in the measConfigAppLayerId list included in the measConfigAppLayer information to be transmitted to the MBS UEs 7-10 and 7-12 through the SIB or MCCH message. The gNB-CU 7-24 transfers measConfigAppLayer including the updated measConfigAppLayerId list to the gNB-DU 7-22 by using a BROADCAST CONTEXT MODIFICATION RESPONSE message in step 7-720, and the gNB-DU 7-22 transmits the BROADCAST CONTEXT MODIFICATION RESPONSE message to the gNB-CU 7-24 as a response in step 7-730.

The gNB-DU 7-22 updates and generates information to be transmitted to the MBS UEs 7-10 and 7-12 on the SIB (e.g., SIB20) or MCCH, based on the MBS broadcast session information, the QMC configuration information, and the like received from the gNB-CU 24 and transfers the information to the UEs 7-10 and 7-12. The gNB-DU 7-22 may transfer information used for receiving the MCCH to the MBS UE 7-10 or 7-12 by using the SIB message in step 7-810 or 7-910, or the gNB-DU 7-22 may transfer configuration information for receiving the MBS service to the MBS UE 7-10 or 7-12 on the MCCH in step 7-820 or 7-920. The MBS UE 7-10 or 7-12 receives an MBS packet for the corresponding MBS broadcast session based on the updated information. The MBS UE 7-10 or 7-12 receives measConfigAppLayer information including the updated QoE measurement and report configuration information on the MCCH in step 7-820 or receives measConfigAppLayer information including the updated QoE measurement and report configuration information through the SIB message in step 7-910.

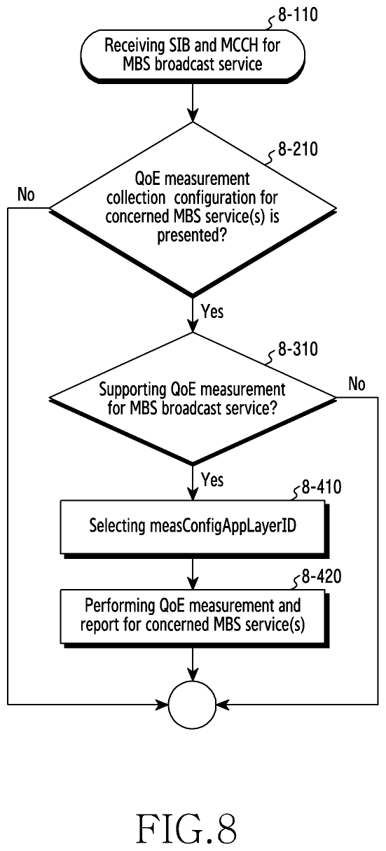

FIG. 8 is a flowchart illustrating a procedure for performing a QoE measurement and report operation with respect to an MBS broadcast session service received by an MBS UE according to an embodiment.

Referring to FIG. 8, in step 8-110, the MBS UE receives configuration information for MBS service reception through an SIB or a message on MCCH to receive an MBS broadcast service.

In step 8-210, the MBS UE identifies whether the information received through the SIB or MCCH message includes QoE measurement and report configuration information with respect to the MBS broadcast session which is being received or to be received by the MBS UE.

If the QoE measurement and report configuration information is not included in step 8-210, the MBS UE may receive MBS broadcast service traffic without a QoE measurement operation.

If the QoE measurement and report configuration information with respect to the MBS broadcast session is included in step 8-210, the MBS UE determines whether a QoE measurement and report function with respect to an MBS broadcast service is supported in step 8-310.

If the QoE measurement and report function with respect to an MBS broadcast service is not supported in step 8-310, the MBS UE may receive MBS broadcast service traffic without a QoE measurement operation.

If QoE measurement and report function with respect to an MBS broadcast service is supported in step 8-310, the MBS UE selects one measConfigAppLayerID in the measConfigAppLayerID list included in the received QoE measurement and report configuration information through the SIB or MCCH message, randomly or according to a rule determined in the UE (e.g., based on UE ID) in step 8-410.

In step 8-420, the MBS UE performs QoE measurement and measurement data storing with respect to the corresponding MBS broadcast session in the MBS broadcast service application while receiving MBS broadcast service traffic and transfers the collected QoE measurement information to the RAB node or the gNB-CU according to a configured QoE measurement report condition.

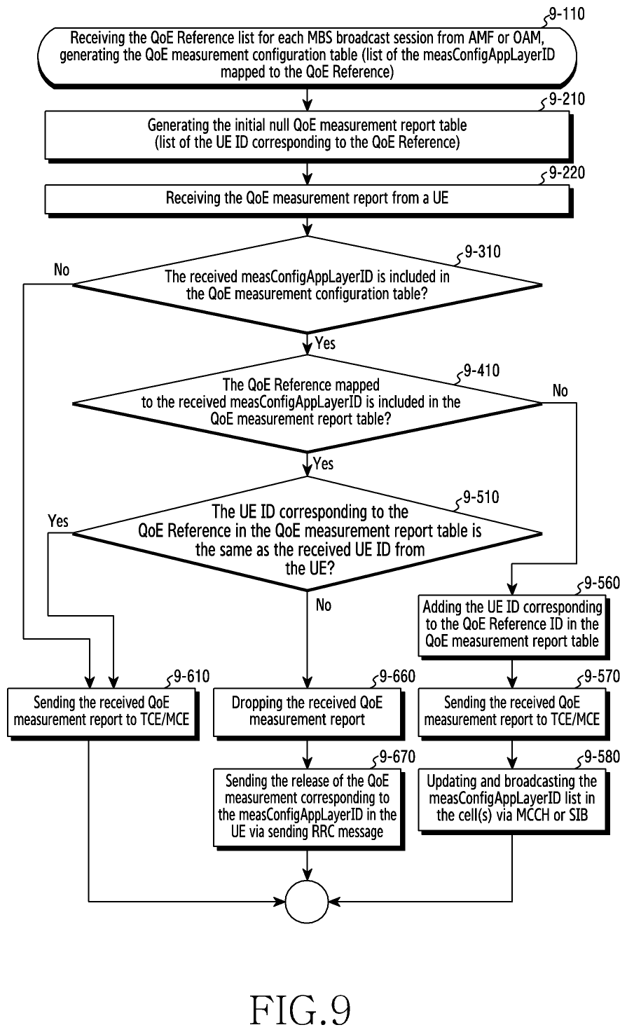

FIG. 9 is a flowchart illustrating a procedure in which a RAN node or a gNB-CU receives a QoE measurement and report with respect to an MBS broadcast session service according to an embodiment.

Referring to FIG. 9, the RAN node or the gNB-CU receives the QoE measurement and report configuration information with respect to the MBS session from the AMF or an OAM server and generates a QoE measurement configuration table based on the QoE reference list included in the configuration information in step 9-110. The QoE measurement configuration table generated by the RAN node or the gNB-CU may include measConfigAppLayerID information mapped for each QoE reference.

In step 9-210, the RAN node or the gNB-CU generates an initialized QoE measurement report table, and an initial table includes no data (i.e., null data). The QoE measurement configuration table generated by the RAN node or the gNB-CU may be for the MBS UE to include and manage a UE ID of the MBS UE which is reported for each QoE reference when performing QoE measurement and report.

In step 9-220, the RAN node or the gNB-CU receives a QoE measurement result report from the MBS UE, and in step 9-310, the RAN node or the gNB-CU identifies whether measConfigAppLayerID is included in the QoE measurement configuration table, based on the information included in a measurement result report message (e.g., a MeasurementReportAppLayer message) transferred from the MBS UE.

In case that the measConfigAppLayerID is not included in the QoE measurement configuration table in step 9-310, the RAN node or the gNB-CU transfers the QoE measurement result report transferred from the MBS UE to the TCE/MCE in step 9-610.

In case that the measConfigAppLayerID received from MBS UE is included in the QoE measurement configuration table in step 9-310, the RAN node or the gNB-CU identifies whether a QoE reference to be mapped to the received measConfigAppLayerID (e.g., based on the QoE measurement configuration table) is included in a QoE measurement report table which is managed by the RAN node or the gNB-CU in step 9-410.

In case that the QoE reference mapped to the received measConfigAppLayerID is not included in the QoE measurement report table in step 9-410, the RAN node or the gNB-CU relates the corresponding QoE reference and the UE ID of the MBS UE having reported the QoE measurement result to be added in the QoE measurement report table in step 9-560. In step 9-570, the RAN node or the gNB-CU transfers the QoE measurement result report transferred from the MBS UE to the TCE/MCE. In step 9-580, the RAN node or the gNB-CU updates a measConfigAppLayer ID list with respect to the corresponding MBS broadcast session to be included in the MCCH or SIB message and transmits same to UEs.

In case that the QoE reference mapped to the received measConfigAppLayerID is included in the QoE measurement report table in step 9-410, the RAN node or the gNB-CU determines whether the UE ID of the MBS UE having reported the QoE measurement result is identical to the UE ID associated with the QoE reference stored in the QoE measurement report table in step 9-510.

In case that the UE ID of the MBS UE having reported the QoE measurement result is identical to the UE ID stored in the QoE measurement report table in step 9-510, the RAN node or the gNB-CU transfers the QoE measurement result report transferred from the MBS UE to the TCE/MCE in step 9-610. However, in case that the UE ID of the MBS UE having reported the QoE measurement result is not identical to the UE ID stored in the QoE measurement report table in step 9-510, the RAN node or the gNB-CU discards (or drops) the QoE measurement report data reported by the MBS UE in step 9-660. In step 9-670, the RAN node or the gNB-CU transfers a message for the MBS UE to release the QoE measurement and report configuration in the corresponding MBS broadcast session service application to the MBS UE 10 by using an RRC connection reconfiguration (e.g., RRCReconfiguration) message.

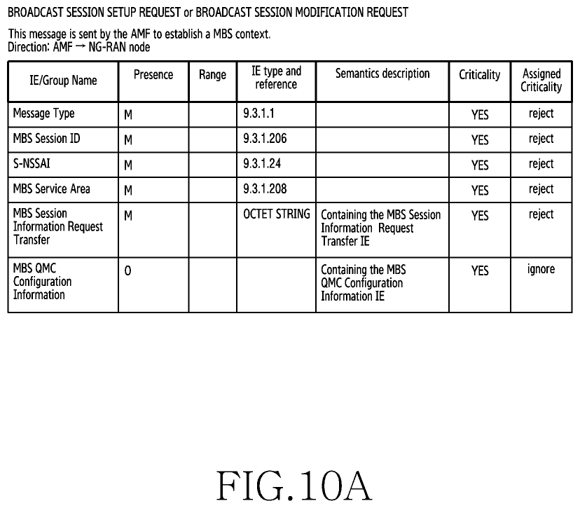

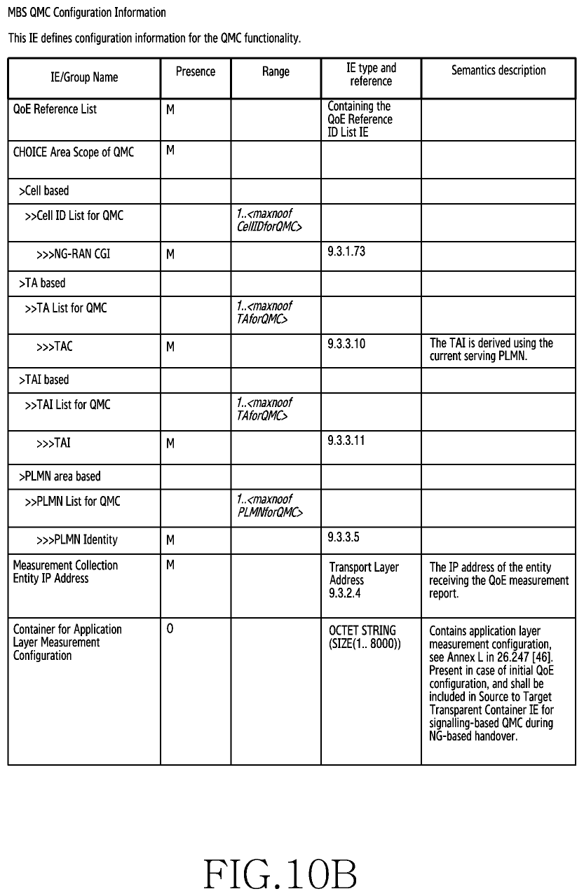

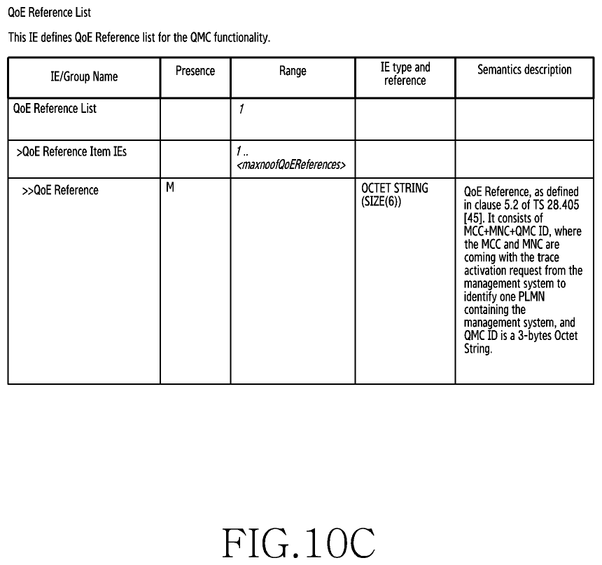

FIG. 10A illustrates an NGAP message according to an embodiment.

Referring to FIG. 10A, the NGAP message may correspond to the message for transferring the QMC configuration information together with the MBS broadcast session configuration information by the AMF, e.g., as described in step 7-110 of FIG. 7. In addition, the NGAP message may include, e.g., a BROADCAST SESSION SETUP REQUEST message or a BROADCAST SESSION MODIFICATION REQUEST message.

The BROADCAST SESSION SETUP REQUEST message or the BROADCAST SESSION MODIFICATION REQUEST message may include information related to the MBS broadcast session MBS, e.g., at least one piece of an MBS session ID, an MBS service area, and MBS session Information, together with QMC configuration information with respect to the corresponding MBS session (MBS QMC configuration information).

FIG. 10B illustrates MBS QMC configuration information according to an embodiment.

Referring to FIG. 10B, the MBS QMC configuration information may include QoE reference list information including one or more pieces of QoE reference information used to identify the QoE measurement result.

FIG. 10C illustrates a QoE reference list according to an embodiment.

Referring to FIG. 10C, the QoE reference list may corresponds to the QoE reference list information described with reference to FIG. 10B. The MBS QMC configuration information may include at least one of area information (area scope) for QoE measurement, an MCE IP address information, and application layer measurement configuration information (e.g., QoE measurement parameter and condition configuration in an application, and QoE measurement report configuration information). The MBS QMC configuration information may further include other information for the QoE measurement configuration and report configuration with respect to the MBS broadcast service such as MCE ID information in addition to the information described above.

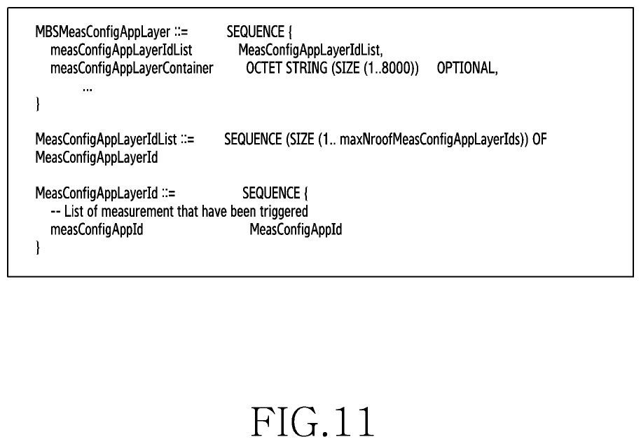

FIG. 11 illustrates MBS measurement-related configuration information according to an embodiment.

Referring to FIG. 11, the MBS measurement-related configuration information may be an example of the RRC message or an IE used for transferring the QMC configuration information with respect to the MBS session by a gNB-CU to a gNB-DU, e.g., as in steps 7-120 and 7-720 of FIG. 7, transferring QMC configuration information with respect to the corresponding broadcast session through the MCCH message in steps 7-220 and 7-820, or transferring the QMC configuration information with respect to the corresponding broadcast session by including same in the SIB message in steps 7-310 and 7-910.

FIG. 11 illustrates an example in which the MBS measurement-related configuration information is realized in an IE (e.g., MBSMeasConfigAppLayer) included in the RRC message. The MBSMeasConfigAppLayer IE may include measConfigAppLayerIdList information including one or more pieces of measConfigAppLayerId information used to identify the QoE measurement result by the RAN node or the gNB-CU and may include measConfigAppLayerContainer information including the QMC configuration information. The measConfigAppLayerContainer information may include area information (area scope) for QoE measurement, an MCE information, application layer measurement configuration information (e.g., QoE measurement parameter and condition configuration in an application, and QoE measurement report configuration information), and other information.

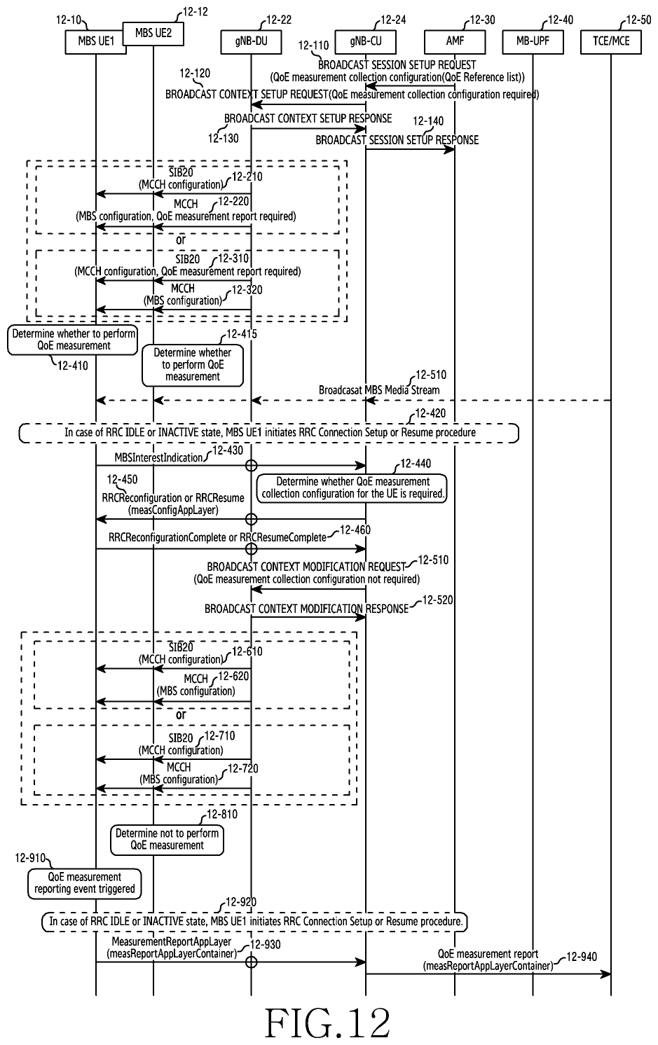

FIG. 12 is a signal flow diagram illustrating a QoE measurement control procedure and report procedure in a UE with respect to an MBS broadcast service together with an MBS broadcast session configuration and a procedure in which a RAN node and a QoE measurement result collection server identify and collect a QoE measurement result for each UE according to an embodiment. Specifically, FIG. 12 illustrates operations related to UEs, among UEs supporting QoE measurement/report function with respect to the MBS broadcast service, for receiving the corresponding MBS broadcast service. More specifically, FIG. 12 is a signal flow diagram illustrating a procedure in which the UEs performs connection to the RAN node according to a QoE measurement/report request of the RAN node, then receive QoE measurement/report configuration information with respect to an MBS broadcast service, perform QoE measurement with respect to the MBS broadcast service, and transfer a QoE measurement report content to the RAN node. The RAN node transfers the QoE measurement report content to a TCE/MCE server.

Referring to FIG. 12, MBS broadcast session connection is started in the CN and the AMF 12-30 transmits a BROADCAST SESSION SETUP REQUEST message to the RAN node gNB-CU 12-24 in step 12-110. The AMF 12-30 may transfer QMC configuration information together with the MBS broadcast session configuration information to the gNB-CU 12-24. The QMC configuration information transferred from the AMF 12-30 to the gNB-CU 12-24 may include one or more values of a QoE reference which is used for identifying and reporting a QoE measurement result for each UE.

The gNB-CU 12-24 transmits a BROADCAST CONTEXT SETUP REQUEST message to the gNB-DU 12-22 in step 12-120, and the BROADCAST CONTEXT SETUP REQUEST message may include QoE measurement report required information and other information for the MBS broadcast service in addition to the MBS broadcast session configuration information.

The gNB-DU 12-22 transmits a BROADCAST CONTEXT SETUP RESPONSE message to the gNB-CU 12-24 in step 12-130, and the gNB-CU 12-24 transmits a BROADCAST SESSION SETUP RESPONSE message to the AMF 12-30 so as to inform that the corresponding MBS broadcast session configuration is completed in step 12-140.

The gNB-DU 12-22 generates and transfers information to be transmitted to the MBS UE 12-10 or 12-12 through an SIB (e.g., SIB20), based on the MBS broadcast session information and the QoE measurement report required information received from the gNB-CU 12-24. Alternatively, the gNB-DU 12-22 generates and transfers information to be transferred to the MBS UE 12-10 or 12-12 on an MCCH, based on the MBS broadcast session information and the QoE measurement report required information received from the gNB-CU 12-24.

In step 12-210 or 12-310, the gNB-DU 12-22 transfers information used for receiving the MCCH to the MBS UE 12-10 or 12-12 by using the SIB message, and in step 12-220 or 12-320, the gNB-DU 12-22 transfers configuration information used for receiving the MBS service to the MBS UE 12-10 or 12-12 on the MCCH. The MBS UE 12-10 or 12-12 receives the QoE measurement report required information on the MCCH (220) or receive the QoE measurement report required information through the SIB message in step 12-310.

The MBS UE 12-10 or 12-12 receives the QoE measurement report required information from the RAN node or gNB-DU 12-22 and identifies whether the QoE measurement report required information with respect to the MBS broadcast session which the MBS UE 12-10 or 12-12 is receiving or to receive is included. Furthermore, in case that the MBS UE 12-10 or 12-12 supports the QoE measurement and report function with respect to an MBS broadcast service, the MBS UE 12-10 or 12-12 determines whether to perform the QoE measurement and report with respect to the corresponding MBS broadcast service in steps 12-410 and 12-415.

The MBS UE 12-10 or 12-12 starts to receive an MBS packet for the corresponding MBS broadcast session in step 12-510.

In case that the MBS UE 12-10 determines to perform the QoE measurement and report with respect to the MBS broadcast service in step 12-410, the MBS UE 12-10 is converted (or transitioned) into the RRC connected state in step 12-420. The MBS UE 12-10 transmits an RRC message (e.g., through an RRC MBSInterestIndication message, through a newly defined RRC message, or by adding, into an existing RRC message like RRC UEAssistanceInformation, a new IE with respect to the MBS broadcast session received or to be received) indicating that the MBS broadcast service is in progress to the gNB-CU 12-22 in step 12-430. If the MBS UE 12-10 is in the RRC connected state already, step 12-420 may be omitted.

Based on the information received from the MBS UE 12-10 on the MBS broadcast session being received or to be received by the MBS UE 12-10 in step 12-430 and the QMC configuration information received from the AMF 12-30 in step 12-110, the gNB-CU 12-24 determines whether the QMC configuration is required for the MBS UE 12-10 in step 12-440. In case that the gNB-CU 12-24 determines to perform the QMC configuration on the MBS UE 12-10, the gNB-CU 12-24 transfers the QoE measurement and report configuration information in the corresponding MBS broadcast session service application to the MBS UE 12-10 by using the RRC connection reconfiguration (e.g., RRCReconfiguration) message transmitted via the gNB-DU 12-22 in step 12-450. The MBS UE 12-10 transmits an RRC connection reconfiguration complete (e.g., RRCReconfigurationComplete) message in step 12-460 and starts the QoE measurement and measurement information storing in the corresponding MBS broadcast session application.

In case that the gNB-CU 12-24 determines that additional QoE measurement and report of the MBS UE 12-10 with respect to the MBS broadcast session is not required for the MBS UE 12-10, the gNB-CU 12-24 transfers a BROADCAST CONTEXT MODIFICATION REQUEST message to the gNB-DU 12-22 in step 12-510. The gNB-CU 12-24 transfers information indicating that the QoE measurement report is not required for the corresponding MBS broadcast session, and the gNB-DU 12-22 transmits the BROADCAST CONTEXT MODIFICATION RESPONSE message to the gNB-CU 12-24 as a response in step 12-520.

When receiving the information indicating that the QoE measurement report is not required for the MBS broadcast session transferred from the gNB-CU 12-24 in step 12-510, the gNB-DU 12-22 updates and transmits information to be transmitted to the MBS UEs 12-10 and 12-12 through the SIB (e.g., SIB20) or a message on the MCCH. The message transmitted to the MBS UE 12-10 or 12-12 may include the information indicating that the QoE measurement report is not required for the corresponding MBS broadcast session or may not include information indicating that the QoE measurement report is required.

The gNB-DU 12-22 may transfer information for receiving the MCCH to the MBS UE 12-10 or 12-12 by using the SIB message in step 12-610 or 12-710, or transfer configuration information for receiving the MBS service to the MBS UE 12-10 or 12-12 through a message on the MCCH in step 12-620 or 12-720. The MBS UEs 12-10 and 12-12 receive an MBS packet for the corresponding MBS broadcast session based on the updated information.

When receiving the information indicating that the QoE measurement report is not required through the message on the MCCH in step 12-620 or 12-720, or receiving the information indicating that the QoE measurement report is not required through the SIB message in step 12-610 or 12-710, the MBS UE 12-12 identifies that the QoE measurement report is not required for the corresponding MBS broadcast session, based on the received information in step 12-810. If a process for requesting configuration information for the QoE measurement and report is in progress, the MBS UE 12-12 may stop a related progress.

In step 12-910, the MBS UE 12-10 having started the QoE measurement and measurement information storing in the MBS broadcast session application may determine that an event (e.g., a periodic report configuration) for reporting a QoE measurement result occurs (or is triggered), based on the QoE report configuration information received in step 12-450). The MBS UE 12-10 is converted (or transitioned) to the RRC connected state in step 12-920, and transfers QoE measurement storage information in an application with respect to the MBS broadcast session service which is being received to the gNB-CU 12-24 through the gNB-DU 12-22 by using the RRC message in step 12-930. If the MBS UE 12-10 is in the RRC connected state already, step 12-920 may be omitted.

The gNB-CU 12-24 having received the QoE measurement information of the MBS broadcast session service application from the MBS UE 12-10 identifies the TCE/MCE 12-50 based on the TCE/MCE information (e.g., a TCE/MCE ID or address) transferred from the AMF 12-30 in step 12-110 and then transfers the QoE measurement information of the MBS broadcast session service application to the TCE/MCE 12-50 in step 12-940.

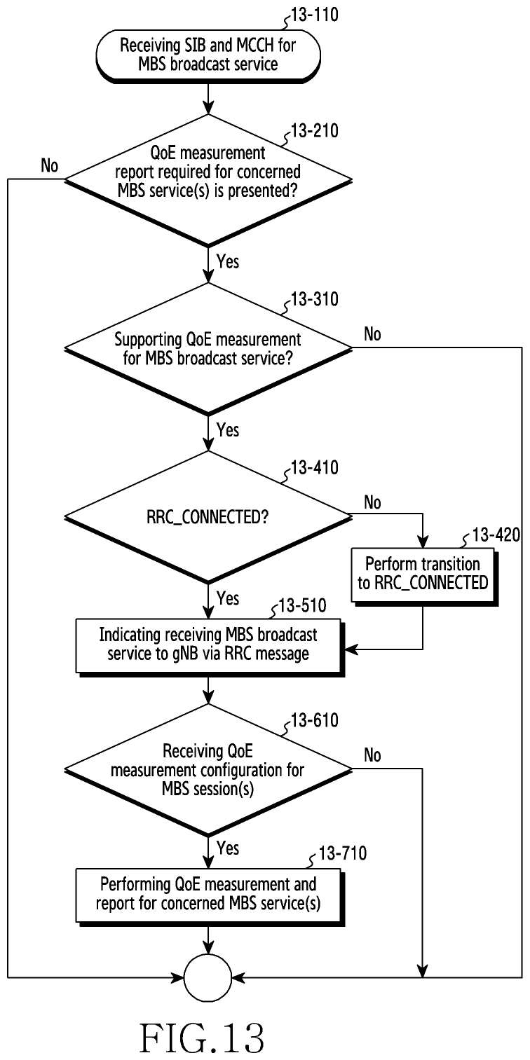

FIG. 13 is a flowchart illustrating a procedure for performing a QoE measurement and report operation with respect to an MBS broadcast session service received by an MBS UE according to an embodiment.

Referring to FIG. 13, in step 13-110, the MBS UE receives configuration information for MBS service reception through an SIB or a message on MCCH message to receive an MBS broadcast service.

In step 13-210, the MBS UE identifies whether the information received through the SIB or MCCH includes QoE measurement and report required configuration information with respect to the MBS broadcast session which is being received or to be received by the MBS UE.

If the QoE measurement and report required configuration information is not included in step 13-210, the MBS UE receives MBS broadcast service traffic without a QoE measurement operation.

In case that the QoE measurement and report required information with respect to the MBS broadcast session that is being received or to be received by the MBS UE is included in information transferred through the SIB or the MCCH in step 13-210, the MBS UE determines if the QoE measurement and report function with respect to the MBS broadcast service is supported in step 13-310.

If the MBS UE does not support the QoE measurement and report function with respect to the MBS broadcast service is supported in step 13-310, the MBS UE receives MBS broadcast service traffic without a QoE measurement operation.

In case that the MBS UE supports the QoE measurement and report function with respect to the MBS broadcast service in step 13-310, the MBS UE identifies whether it is in an RRC connected state (RRC CONNECTED) in step 13-410.

In case that the MBS UE is not in the RRC connected state in step 13-410, the MBS UE performs an operation for changing to the RRC connected state in step 13-420.

The MBS UE, in the RRC connected state, transfers the information on the MBS broadcast session being received or to be received by the MBS UE to the RAN node or the gNB-CU by using the RRC message in step 13-510.

The MBS UE receives an RRC connection reconfiguration (e.g., RRCReconfiguration) message from the RAN node or the gNB-CU and determines whether this RRC message includes the QoE measurement and report configuration information with respect to the MBS broadcast session in step 13-610.

In case that the RRC connection reconfiguration (e.g., RRCReconfiguration) message does not include the QoE measurement and report configuration information with respect to the MBS broadcast session in step 13-610, the MBS UE receives MBS broadcast service traffic without a QoE measurement operation.

In case that the RRC connection reconfiguration (e.g., RRCReconfiguration) message includes the QoE measurement and report configuration information with respect to the MBS broadcast session in step 13-610, the MBS UE performs, with respect to the corresponding MBS broadcast session, QoE measurement and measurement data storing with respect to the corresponding MBS broadcast session in the MBS broadcast service application while receiving MBS broadcast service traffic in step 13-710. The MBS UE transfers the collected QoE measurement information to the RAN node or the gNB-CU according to a configured QoE measurement report condition.

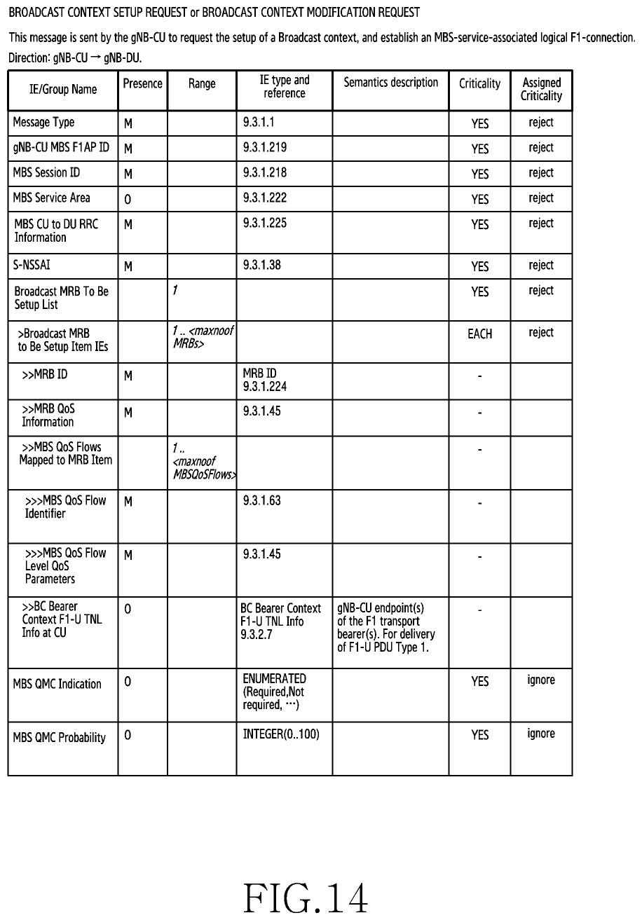

FIG. 14 illustrates an F1AP message according to an embodiment.

Referring to FIG. 14, the F1AP message may correspond to the message used for transferring the QMC configuration information together with the MBS broadcast session configuration information by a gNB-CU to a gNB-DU, e.g., as in step 12-120 or step 12-510 in FIG. 12. The F1AP message may include a BROADCAST CONTEXT SETUP REQUEST message or a BROADCAST CONTEXT MODIFICATION REQUEST message.

The BROADCAST CONTEXT SETUP REQUEST message or the BROADCAST CONTEXT MODIFICATION REQUEST message may include information related to the MBS broadcast session configuration, for example, at least one piece of an MBS session ID, an MBS DRB ID, and QoS flow Information, together with information (e.g., an MBS QMC indication IE) indicating that the QoE measurement and report configuration is required with respect to the corresponding MBS session. The information related to the MBS broadcast session configuration may include only information (e.g., possible to include only a “required” value) indicating that the QoE measurement and report configuration is required, or may include information (e.g., including “required” or “not required” information) indicating that the QoE measurement and report configuration is required or is not required. Furthermore, in case that the information indicating that the QoE measurement and report configuration is required is included in the information related to the MBS broadcast session configuration, in order to not have all MBS UEs perform a procedure for the QoE measurement and report configuration, the information related to the MBS broadcast session configuration may further include a probability value (e.g., an MBS QMC Probability IE) information for determining whether to perform the procedure for the QoE measurement and report configuration. The probability value (e.g., an MBS QMC Probability IE) information for the MBS UE to determine whether to initiate the procedure for the QoE measurement and report configuration is transferred to the UE through the SIB or MCCH message, and the MBS UE having received the information may generate, e.g., a random parameter value and then start the procedure for the QoE measurement and report configuration when the generated value is smaller than a probability value received from the RAN node.

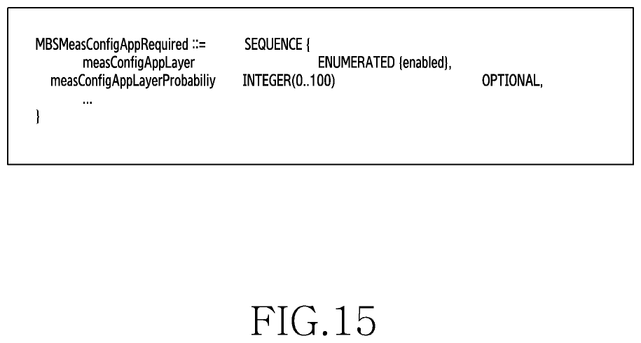

FIG. 15 illustrates MBS measurement-related configuration information according to an embodiment.

Referring to FIG. 15, the MBS measurement-related configuration information may be a configuration of an IE or an RRC message used for transferring the QoE measurement and report required information with respect to the corresponding MBS broadcast to the MBS UEs, e.g., as included in the MCCH message in steps 12-220 and 12-620 and the SIB message in step 12-310 or 12-710 of FIG. 12.

For example, FIG. 15 illustrates the MBS measurement-related configuration information being realized in an IE (e.g., MBSMeasConfigAppRequired) included in the RRC message. The MBSMeasConfigAppRequired IE may include information (e.g., mbsConfigAppLayer information) including the QoE measurement and report required information and the probability value (e.g., mbsConfigAppLayerProbability) information for the MBS UE to determine whether to initiate the procedure for the QoE measurement and report configuration. When receiving the probability value (e.g., an MBS QMC Probability IE) information for determining whether to initiate the procedure for the QoE measurement and report configuration, the MBS UE may generate, e.g., a random parameter value and then start the procedure for the QoE measurement and report configuration when the generated value is smaller than a probability value received from the RAN node.

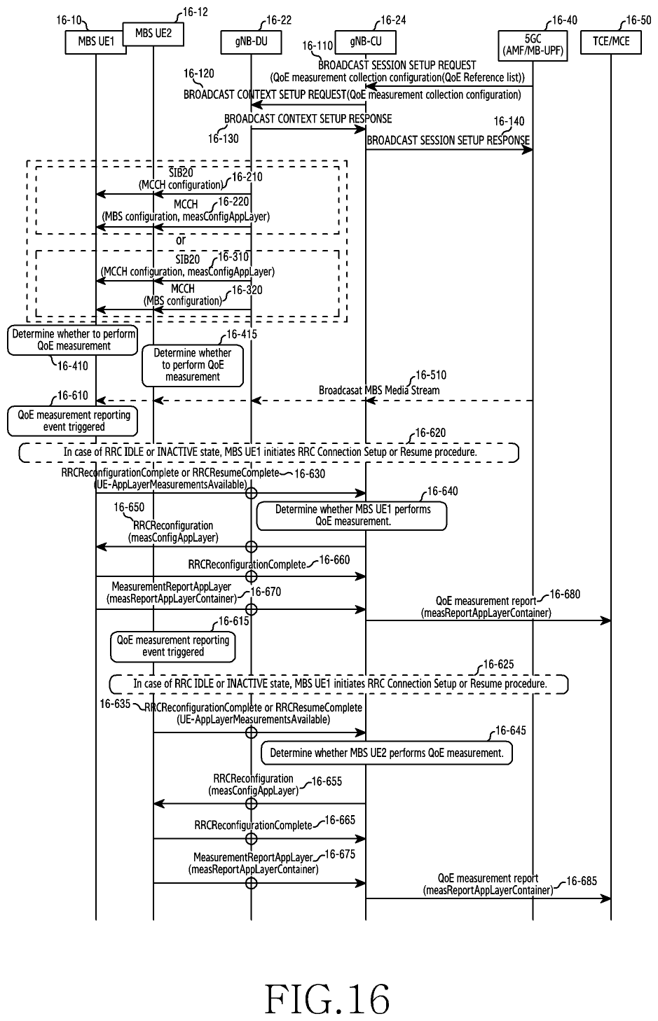

FIG. 16 is a signal flow diagram illustrating a QoE measurement control procedure and report procedure in a UE with respect to an MBS broadcast service together with an MBS broadcast session configuration and a procedure in which a RAN node and a QoE measurement result collection server identify and collect a QoE measurement result for each UE according to an embodiment. Specifically, FIG. 16 may explain operations related to UEs, among UEs supporting QoE measurement/report function with respect to the MBS broadcast service, for receiving the corresponding MBS broadcast service. More Specifically, FIG. 16 illustrates a procedure in which UEs receive and report common QoE measurement/report configuration information and a procedure in which an RAN node allocates a value for identifying a QoE measurement report content for each UE before the MBS UE reports the QoE measurement information so that the RAN node identifies the QoE measurement report content for each UE and transfers same to the TCE/MCE server.

Referring to FIG. 16, an MBS broadcast session connection is started in the CN and the AMF 16-30 transmits a BROADCAST SESSION SETUP REQUEST message to the RAN node gNB-CU 16-24 in step 16-110. Here, the AMF 16-30 may transfer QMC configuration information together with the MBS broadcast session configuration information to the gNB-CU 16-24. The QMC configuration information transferred from the AMF 16-30 to the gNB-CU 16-24 may include one or more values of a QoE reference which is used for identifying and reporting a QoE measurement result for each UE.

The gNB-CU 16-24 transmits a BROADCAST CONTEXT SETUP REQUEST message to the gNB-DU 16-22 in step 16-120, and the BROADCAST CONTEXT SETUP REQUEST message may further include QMC configuration information and other information for the MBS broadcast service in addition to the MBS broadcast session configuration information. The QMC configuration information transferred from the gNB-CU 16-24 to the gNB-DU 16-22 may not include measConfigAppLayerId information which is used as an indicator (or identifier) for the MBS UE 16-10 or 16-12 to identify a QoE measurement result while collecting MBS broadcast service QoE measurement information data. The gNB-DU 16-22 transmits a BROADCAST CONTEXT SETUP RESPONSE message to the gNB-CU 16-24 in step 16-130, and the gNB-CU 16-24 transmits a BROADCAST SESSION SETUP RESPONSE message to the AMF 16-30 so as to inform that the corresponding MBS broadcast session configuration is completed in step 16-140.

The gNB-DU 16-22 may generate and transfer information to be transmitted to the MBS UE 16-10 or 16-12 through the SIB (e.g., SIB20) or a message on the MCCH, based on the MBS broadcast session information, the QMC configuration information, etc., received from the gNB-CU 16-24. The gNB-DU 16-22 transfers information for receiving the MCCH by using the SIB message in step 16-210 or 16-310, and transfers configuration information for receiving the MBS service through a message on the MCCH in step 16-220 or 16-320. The MBS UE 16-10 or 16-12 receives the QoE measurement and report configuration information through a message on the MCCH in step 16-220 or receives the QoE measurement and report configuration information through the SIB message in step 16-310. The measConfigAppLayer may not include measConfigAppLayerId used as an identifier for identifying the QoE measurement result.

In case that the MBS UE 16-10 or 16-12 receives measConfigAppLayer information including the QoE measurement and report configuration information from the RAN node gNB-DU 16-22, the MBS UE 16-10 or 16-12 identifies whether the QoE measurement and report configuration information is included with respect to the MBS broadcast session which is being received or to be received. In case that the MBS UE 16-10 or 16-12 supports the QoE measurement and report function with respect to an MBS broadcast service, the MBS UE 16-10 or 16-12 determines performance of the QoE measurement and report function with respect to the corresponding MBS broadcast service in step 16-410 or 16-415 and starts the QoE measurement and measurement result storing in a corresponding MBS broadcast session application.

The MBS UE 16-10 or 16-12 starts to receive an MBS packet for the corresponding MBS broadcast session in step 16-510.

When an event (e.g., a periodic report configuration) for reporting the QoE measurement result based on the received QoE report configuration information occurs on the MBS UE 16-10 in step 16-610, the MBS UE 16-10 is converted (or transitioned) to an RRC connected state in step 16-620. By using the RRC connection reconfiguration complete message (e.g., the RRCReconfigurationComplete message or the RRCResumeComplete message) during conversion to the RRC connected state and by using the RRC message when in the RRC connected state, the MBS UE 16-10 adds an indicator (e.g., a UE-AppLayerMeasurementsAvailable IE) indicating that the MBS UE 16-10 has stored QoE measurement result information to the messages to be transferred to the gNB-CU 16-24 in step 16-630. The indicator or information may include information on the corresponding MBS broadcast session. When determining that reception of the QoE measurement information from the MBS UE 16-10 is required in step 16-640, the gNB-CU 16-24 includes the measConfigAppLayer configuration information with respect to the corresponding MBS broadcast session in the RRC connection reconfiguration message (e.g., an RRCReconfiguration message) and transfers the message to the MBS UE 16-10 in step 16-650. The configuration information may include measConfigAppLayerId to be used as an identifier for identifying the QoE measurement result.

The MBS UE 16-10 transmits the RRC connection reconfiguration complete message as a response in step 16-660. The MBS UE 16-10 transfers the QoE measurement storage information in an application with respect to the MBS broadcast session service to the gNB-CU 16-24 through the gNB-DU 22 by using the RRC message according to the QoE report configuration information with respect to the MBS broadcast session received through the RRC reconfiguration message in step 16-670. The gNB-CU 16-24 identifies the TCE/MCE 16-50 based on the TCE/MCE information (e.g., a TCE/MCE ID or address) transferred from the AMF 16-30 and then transfers the QoE measurement information of the MBS broadcast session service application to the TCE/MCE 16-50 in step 16-680.

When an event (e.g., a periodic report configuration) for reporting the QoE measurement result based on the received QoE report configuration information occurs on the MBS UE 16-12 in step 16-615, the MBS UE 16-20 is converted (or transitioned) to an RRC connected state in step 16-625. By using the RRC connection reconfiguration complete message (e.g., the RRCReconfigurationComplete message or the RRCResumeComplete message) during conversion to the RRC connected state and by using the RRC message when in the RRC connected state, the MBS UE 16-12 adds an indicator (e.g., a UE-AppLayerMeasurementsAvailable IE) indicating that the MBS UE 16-12 has stored QoE measurement result information to the messages to be transferred in step 16-635 to the gNB-CU 16-24. The indicator or information may include information on the corresponding MBS broadcast session.

When determining that reception of the QoE measurement information from the MBS UE 16-12 is required in step 16-645, the gNB-CU 16-24 includes the measConfigAppLayer configuration information with respect to the corresponding MBS broadcast session in the RRC connection reconfiguration message (e.g., an RRCReconfiguration message) and transfers the message to the MBS UE 16-12 in step 16-655. The configuration information may include measConfigAppLayerId to be used as an identifier for identifying the QoE measurement result. In step 16-655, the measConfigAppLayerId transferred from the gNB-CU 24 to the MBS UE 12 may have a different value from the measConfigAppLayerId transferred from the gNB-CU 16-24 to the MBS UE 16-10 in step 16-650.

In step 16-665, the MBS UE 16-12 transmits the RRC connection reconfiguration complete message as a response. The MBS UE 16-12 transfers the QoE measurement storage information in an application with respect to the MBS broadcast session service to the gNB-CU 16-24 through the gNB-DU 16-22 by using the RRC message according to the QoE report configuration information with respect to the MBS broadcast session received through the RRC reconfiguration message in step 16-675. The gNB-CU 16-24 identifies the TCE/MCE 16-50 based on the TCE/MCE information (e.g., a TCE/MCE ID or address) transferred from the AMF 16-30 and then transfers the QoE measurement information of the MBS broadcast session service application to the TCE/MCE 16-50 in step 16-685.

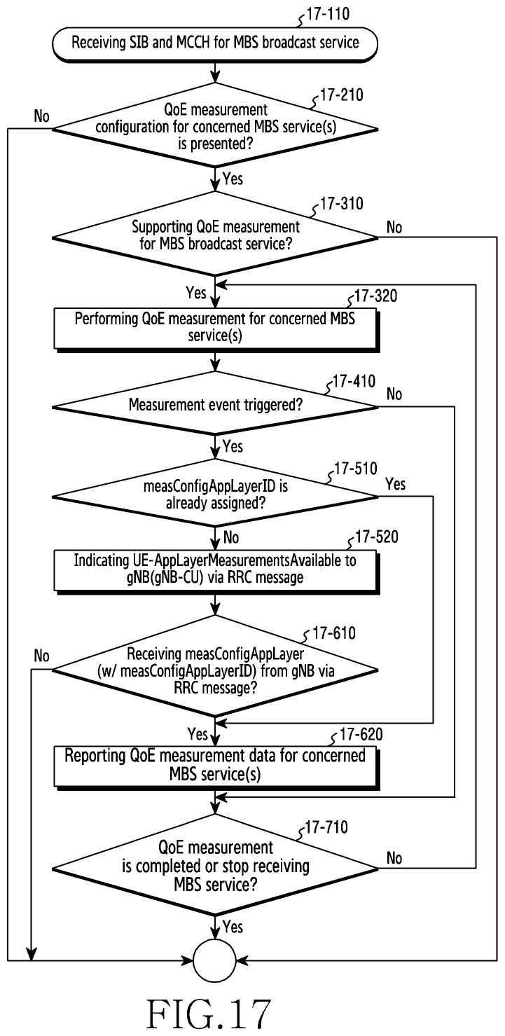

FIG. 17 is a flowchart illustrating a procedure for performing a QoE measurement and report operation with respect to an MBS broadcast session service received by an MBS UE according to an embodiment.

Referring to FIG. 17, in step 17-110, the MBS UE receives configuration information for MBS service reception through an SIB or a message on MCCH message to receive an MBS broadcast service.

In step 17-210, the MBS UE identifies whether the information received through the SIB or MCCH includes the QoE measurement and report configuration information with respect to the MBS broadcast session which is being received or to be received by the MBS UE.

If the QoE measurement and report configuration information is not included in step 17-210, the MBS UE receives MBS broadcast service traffic without a QoE measurement operation.

In case that the QoE measurement and report configuration information with respect to the MBS broadcast session that is being received or to be received by the MBS UE is included in information transferred through the SIB or the MCCH in step 17-210, the MBS UE determines whether the QoE measurement and report function with respect to the MBS broadcast service is supported in step 17-310.

If the MBS UE does not support the QoE measurement and report function with respect to the MBS broadcast service in step 17-310, the MBS UE receives MBS broadcast service traffic without a QoE measurement operation.

In case that the MBS UE supports the QoE measurement and report function with respect to the MBS broadcast service in step 17-310, the MBS UE performs the QoE measurement and measurement data storing with respect to the corresponding MBS broadcast session in the MBS broadcast service application while receiving the MBS broadcast service traffic in step 17-320.

In step 17-410, the MBS UE determines whether an event (e.g., a periodic report configuration) for reposing the QoE measurement result occurs or is triggered in the MBS UE based on the previously received configuration information.

In case that a report event does not occur in step 17-410, the MBS UE determines whether the QoE measurement and report is completed or stopped in step 17-710.

If the QoE measurement and report is not completed or stopped in step 17-710, the MBS UE repeats the procedure from step 17-320.

In case that a report event does not occur or is not triggered in step 17-410, the MBS UE determines whether an identifier (e.g., measConfigAppLayerID) for reporting the QoE measurement information of the corresponding MBS broadcast session application has been already allocated from the RAN node or the RAN node gNB-CU in step 17-510.

In case that the MBS UE has been already allocated an identifier ((e.g., measConfigAppLayerID) for reporting the QoE measurement information in step 17-510, the MBS UE performs a procedure for transferring the QoE measurement information of the corresponding MBS broadcast session application to the RAN node or the RAN node gNB-CU in step 17-620. Thereafter, in step 17-710, the MBS UE completes or stops the procedure for the QoE measurement and report when the QoE measurement and report is completed or stopped in step 17-710, and repeats a procedure from step 17-320, when the QoE measurement and report continues.

In case that an identifier (e.g., measConfigAppLayerID) for reporting the QoE measurement information of the corresponding MBS broadcast session application has not been received from the RAN node or the RAN node gNB-CU in step 17-510, the MBS UE informs the RAN node or the RAN node gNB-CU that the QoE measurement information of the MBS broadcast session application is stored in step 17-520.

The MBS UE receives the RRC connection reconfiguration message from the RAN node or the RAN node gNB-CU.

In case that the RRC connection reconfiguration message received from the RAN node or the RAN node gNB-CU does not include the identifier (e.g., measConfigAppLayerID) for reporting the QoE measurement and report configuration information with respect to the corresponding MBS broadcast session or the QoE measurement information of the corresponding MBS broadcast session application, or a request for releasing the QoE measurement and report with respect to the corresponding MBS broadcast session is received, the MBS UE completes or stops the procedure for the QoE measurement and report and receives only MBS broadcast session data.

In case that the QoE measurement and report configuration information with respect to the corresponding MBS broadcast session, which includes an identifier (e.g., measConfigAppLayerID) for reporting the QoE measurement information of the corresponding MBS broadcast session application, is received in step 17-610, the MBS UE performs a procedure for transferring the QoE measurement information of the corresponding MBS broadcast session application to the RAN node or the RAN node gNB-CU in step 17-620.

Thereafter, the MBS UE completes or stops the procedure for the QoE measurement and report when the QoE measurement and report is completed or stopped in step 17-710 and repeats a procedure from step 17-320, when the QoE measurement and report continues.

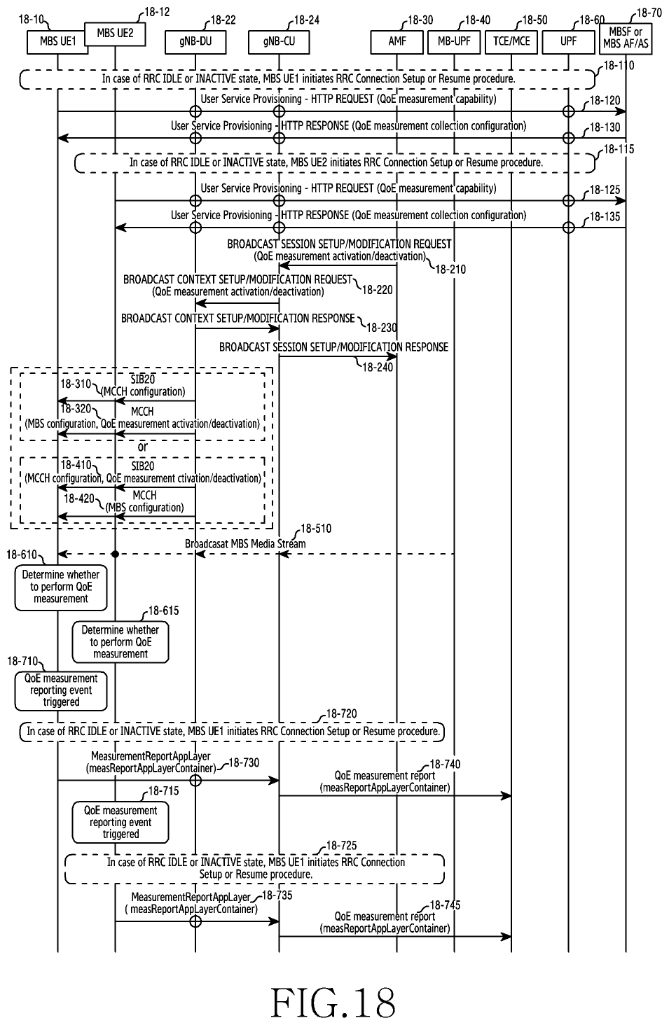

FIG. 18 is a signal flow diagram illustrating a QoE measurement control procedure and report procedure of a UE with respect to an MBS broadcast service together with an MBS broadcast session configuration according to an embodiment. Specifically, in FIG. 18, the MBS UE 18-10 or 18-12 may perform communication with an MBSF or MBS AF/AS through data communication to receive information configuration of the MBS broadcast session. Specifically, FIG. 18 illustrates, in case that the MBS UE 18-10 or 18-12 supports the QoE measurement/report function with respect to the MBS broadcast service and receives the corresponding MBS broadcast service, a process in which the QoE measurement/report information is configured to the MBS UE 18-10 or 18-12, a process in which the MBS UE 18-10 or 18-12 performs the QoE measurement and storing of the corresponding MBS broadcast session application according to the configured QoE measurement/report, and a procedure in which the MBS UE 18-10 or 18-12 reports the QoE measurement and stored result to the RAN node and the QoE measurement result collection server.

Referring to FIG. 18, in case that the MBS UE 18-10 wants to receive the MBS broadcast service and the MBS UE 18-10 is not in the RRC connected state, the MBS UE 18-10 performs a procedure for conversion to the RRC connected state in step 18-110. The MBS UE 18-10 performs a procedure for connection to an MBSF or an MBS AF/AS through signaling with the gNB-DU 18-22, the gNB-CU 18-24, a UPF 18-60, etc.

The MBS UE 18-10 transmits a service request for the MBS broadcast service to the MBSF or MBS AF/AS through a communication method (e.g., HTTP REQUEST or HTTP POST) such as a HTTP message in step 18-120, and the MBS UE 18-10 transfers information on a function (or capability) supporting the QoE measurement and report function with respect to the MBS broadcast service application together. Through a data communication method (e.g., HTTP RESPONSE) such as the HTTP message, the MBSF or the MBS AF/AS 18-70 transfers, to the MBS UE 18-10, information related to the MBS broadcast session and reception with respect to the MBS broadcast service requested by the UE in step 18-130. The MBSF or the MBS AF/AS 18-70 may transfer the QoE measurement and report configuration information with respect to the MBS broadcast service application for the corresponding MBS broadcast session together to the MBS UE 18-10. The QoE measurement and report configuration information with respect to the MBS broadcast service application may include at least one of an identifier (e.g., QoE Reference information or measConfigAppLayerID) for reporting the QoE measurement information of the corresponding MBS broadcast session application, area information (area scope) for the QoE measurement, an MCE IP address information, and application layer measurement configuration information (e.g., QoE measurement parameter and condition configuration in an application, and QoE measurement report configuration information), and may further include other information for the QoE measurement configuration information and report configuration with respect to the MBS broadcast service, such as MCE ID information.

With respect to another MBS UE 18-12, in case that the MBS UE 18-12 wants to receive the MBS broadcast service and the MBS UE 18-12 is not in the RRC connected state, the MBS UE 18-12 performs a procedure for conversion (or transition) to the RRC connected state in step 18-115. The MBS UE 18-12 performs a procedure for connection to an MBSF or an MBS AF/AS 18-70 through signaling with the gNB-DU 18-22, the gNB-CU 18-24, the UPF 18-60, etc. The MBS UE 18-12 transmits a service request for the MBS broadcast service to the MBSF or MBS AF/AS 18-70 through a communication method (e.g., HTTP REQUEST or HTTP POST) such as an HTTP message in step 18-125 and the MBS UE 187-12 transfers information on a function (or capability) supporting the QoE measurement and report function with respect to the MBS broadcast service application together. Through a data communication method (e.g., HTTP RESPONSE) such as the HTTP message, the MBSF or the MBS AF/AS 18-70 transfers, to the MBS UE 18-12, information related to the MBS broadcast session and reception with respect to the MBS broadcast service requested by the MBS UE 18-12 in step 18-135. The MBSF or the MBS AF/AS 18-70 may transfer the QoE measurement and report configuration information with respect to the MBS broadcast service application for the corresponding MBS broadcast session together to the MBS UE 18-12. The QoE measurement and report configuration information with respect to the MBS broadcast service application may include at least one of an identifier (e.g., QoE Reference information or measConfigAppLayerID) for reporting the QoE measurement information of the corresponding MBS broadcast session application, area information (area scope) for the QoE measurement, an MCE IP address information, and application layer measurement configuration information (e.g., QoE measurement parameter and condition configuration in an application, and QoE measurement report configuration information), and may further include other information for the QoE measurement configuration information and report configuration with respect to the MBS broadcast service, such as MCE ID information.

When MBS broadcast session connection is started in the CN, the AMF 18-30 transmits a BROADCAST SESSION SETUP REQUEST message to the RAN node gNB-CU 18-24 in step 18-210. Here, the AMF 18-30 transfers information for indicating whether the QMC is activated or deactivated together with the MBS broadcast session configuration information.

The gNB-CU 18-24 transmits the BROADCAST CONTEXT SETUP REQUEST message to the gNB-DU 18-22 in step 18-220 and transfers information for indicating whether the QoE measurement and report is activated or deactivated together with configuration information for each MBS broadcast session. The gNB-DU 18-22 transmits a BROADCAST CONTEXT SETUP RESPONSE message to the gNB-CU 18-24 in step 18-230, and the gNB-CU 18-24 transmits a BROADCAST SESSION SETUP RESPONSE message to the AMF 18-30 so as to inform that the corresponding MBS broadcast session configuration is completed in step 18-240.

The gNB-DU 18-22 may generate and transfer information to be transmitted to the MBS UE 18-10 or 18-12 through the SIB (e.g., SIB20) or a message on the MCCH, based on the MBS broadcast session information and the QoE measurement and report activation/deactivation information, and the like received from the gNB-CU 18-24. The gNB-DU 18-22 transfers information for receiving the MCCH by using the SIB message in step 18-310 or 18-410, and transfers configuration information for receiving the MBS service through a message on the MCCH in step 18-320 or 18-420.

The MBS UE 18-10 or 18-12 starts to receive an MBS packet for the corresponding MBS broadcast session in step 18-510.

The MBS UE 18-10 or 18-12 may receive the QoE measurement and report activation/deactivation information through a message on the MCCH in step 18-320 or receive the QoE measurement and report activation/deactivation information through the SIB message in step 18-410. In case that the MBS UE 18-10 or 18-12 receives QoE measurement and report activation information from the RAN node gNB-DU 18-22 in step 18-320 or 18-410, the MBS UE 18-10 or 18-12 identifies whether the QoE measurement and report configuration information is included with respect to the MBS broadcast session which is being received or to be received in step 18-610 or 18-615. The MBS UE 18-10 or 18-12 starts the QoE measurement and measurement information storing in the corresponding MBS broadcast session application.

In case that an event (e.g., a periodic report configuration) for reporting the QoE measurement result based on the received QoE report configuration information occurs in step 18-710 or 18-715, the MBS UE 18-10 or 18-12 is converted (or transitioned) to the RRC connected state in step 18-720 or 18-725. The MBS UE 18-10 or 18-12 transfers QoE measurement storage information in an application with respect to the MBS broadcast session service which is being received to the gNB-CU 18-24 through the gNB-DU 18-22 by using the RRC message in step 18-730 or 18-735. If the MBS UE 18-10 or 18-12 is in the RRC connected state already, steps 18-720 or 18-725 may be omitted.

The gNB-CU 18-24 having received the QoE measurement information of the MBS broadcast session service application from the MBS UE 18-10 or 18-12 identifies the TCE/MCE 18-50, based on TCE/MCE information (e.g., a TCE/MCE ID or IP address) transferred from the AMF 18-30 or the TCE/MCE information (e.g., a TCE/MCE ID or IP address) included in the QoE measurement information of the MBS broadcast session service application transferred from the MBS UE 18-10 or 18-12, and then transfers the QoE measurement information of the MBS broadcast session service application to the TCE/MCE 18-50 in step 18-740 or 18-745.

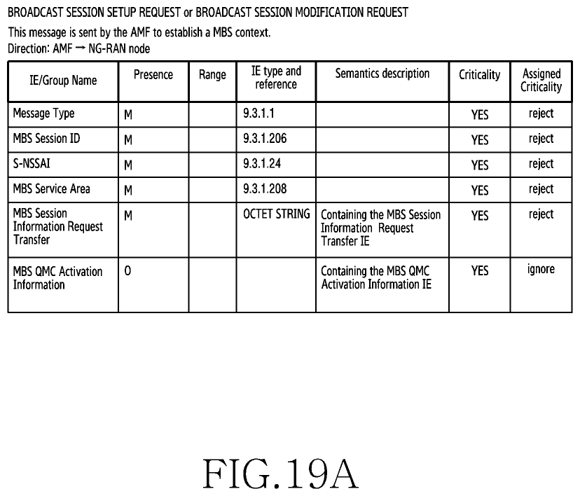

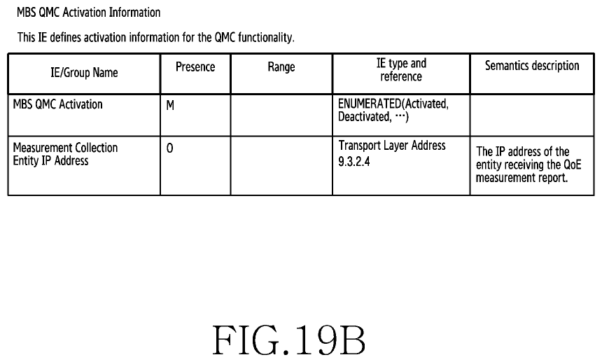

FIG. 19A illustrates an NGAP message according to an embodiment.

Referring to FIG. 19A, the NGAP message may correspond to the message used for transferring the QMC activation information together with the MBS broadcast session configuration information by the AMF 30, e.g., as described in step 18-210 of FIG. 18. In addition, this NGAP message may include, e.g., a BROADCAST SESSION SETUP REQUEST message or a BROADCAST SESSION MODIFICATION REQUEST message. The BROADCAST SESSION SETUP REQUEST message or the BROADCAST SESSION MODIFICATION REQUEST message may include information related to the MBS broadcast session MBS, e.g., at least one piece of an MBS session ID, an MBS service area, and MBS session information, together with QMC activation information with respect to the corresponding MBS session (e.g., MBS QMC activation Information).

FIG. 19B illustrates MBS QMC activation information according to an embodiment.

Referring to FIG. 19B, the MBS QMC activation information may include QoE measurement and report activation information (e.g., MBS QMC activation) in an application with respect to the corresponding MBS broadcast session service and an IP address for the TCE/MEC server. Furthermore, the MBS QMC activation information may further include other information for the QoE measurement configuration and report configuration with respect to the MBS broadcast service, such as TCE/MCE ID information, in addition to the information described above.

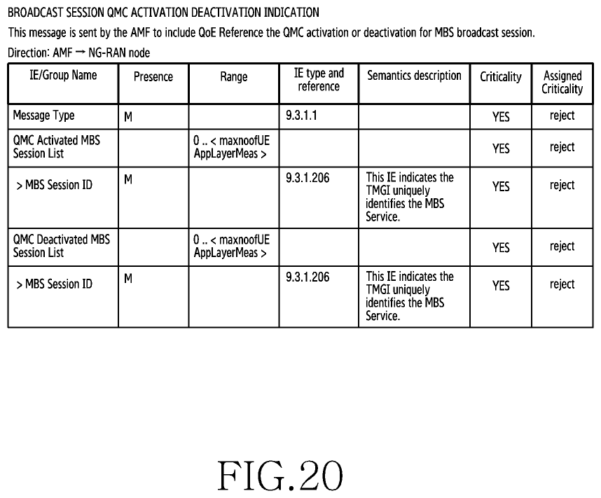

FIG. 20 illustrates an NGAP message according to an embodiment.

Referring to FIG. 20, the NGAP message may correspond to an NGAP message used by an AMF to separately transfer the QMC activation and deactivation information instead of the NGAP message (e.g., the BROADCAST SESSION SETUP REQUEST message or the BROADCAST SESSION MODIFICATION REQUEST message) used by the AMF to transfer the QMC activation information, e.g., as described in step 18-210 of FIG. 18. The NGAP message in FIG. 20 may correspond to, e.g., a BROADCAST SESSION QMC ACTIVATION DEACTIVATION INDICATION message. The BROADCAST SESSION QMC ACTIVATION DEACTIVATION INDICATION message of FIG. 20 may be transferred from the AMF to a RAN node or a gNB-CU separately from the BROADCAST SESSION SETUP REQUEST message or the BROADCAST SESSION MODIFICATION REQUEST message, e.g., as used in step 18-210 of FIG. 18.

The BROADCAST SESSION QMC ACTIVATION DEACTIVATION INDICATION message may include an MBS session ID list of MBS broadcast services of which QMC is required to be activated and an MBS session ID list of MBS broadcast services of which QMC is required to be deactivated, and may include either activation or deactivation information or both information.

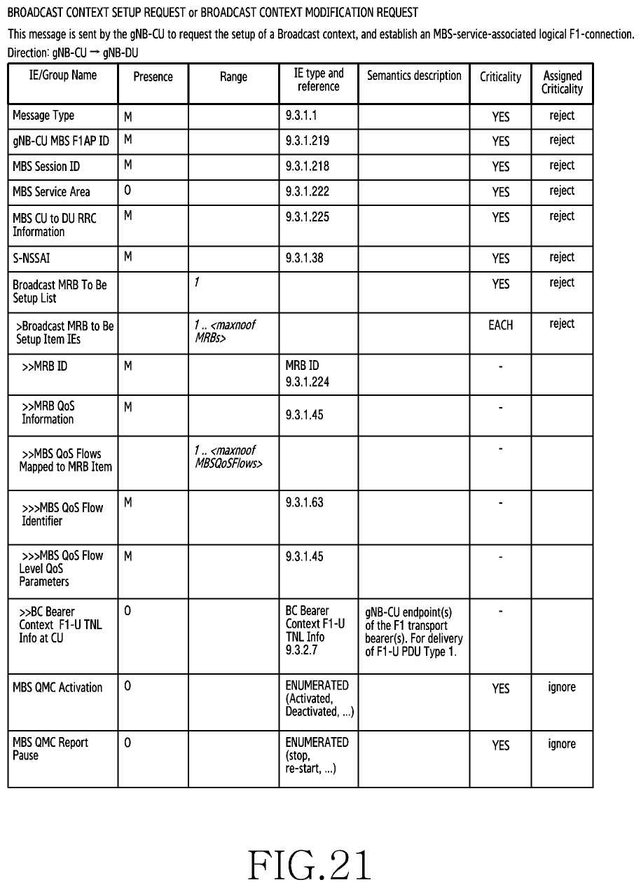

FIG. 21 illustrates an F1AP message according to an embodiment. The F1AP message may correspond to the message used for transferring the QMC configuration information together with the MBS broadcast session configuration information by a gNB-CU, e.g., as described in step 18-220 of FIG. 18. Furthermore, the F1AP message may include, e.g., a BROADCAST CONTEXT SETUP REQUEST message or a BROADCAST CONTEXT MODIFICATION REQUEST message. The BROADCAST CONTEXT SETUP REQUEST message or the BROADCAST CONTEXT MODIFICATION REQUEST message may include information related to the MBS broadcast session configuration, e.g., at least one piece of MBS session ID, MBS DRB ID, and QoS flow Information, together with the QMC activation information (e.g., MBS QMC activation) with respect to the corresponding MBS session. In addition, the BROADCAST CONTEXT SETUP REQUEST message or the BROADCAST CONTEXT MODIFICATION REQUEST message may include information (e.g., MBS QMC report pause) indicating QoE measurement result report and restart with respect to the MBS broadcast session for indicating whether to report the QoE measurement result information in the MBS UE. The information indicating QoE measurement result report and restart may be transferred for each MBS broadcast session or may be transferred as information for the entire MBS broadcast session by using another F1AP message. Furthermore, the information indicating QoE measurement result report and restart may be transmitted by the RAN node according to a load state of the RAN node or the gNB-CU. The BROADCAST CONTEXT SETUP REQUEST message or the BROADCAST CONTEXT MODIFICATION REQUEST message may further include other information for the QoE measurement configuration and report configuration with respect to the MBS broadcast service, such as an IP address with respect to the TCE/MCE server and TCE/MCE ID information.

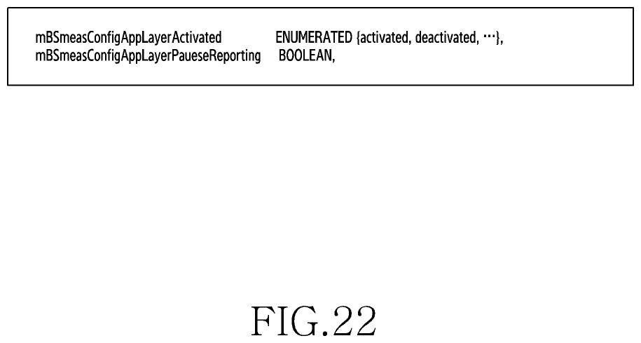

FIG. 22 illustrates MBS measurement-related configuration information related to an embodiment of the disclosure.

Referring to FIG. 22, the MBS measurement-related configuration information may correspond to information included in the MCCH message, e.g., as in step 18-320 of FIG. 18 or the SIB message in step 18-410, and may be an example of an IE used for transferring the QMC activation/deactivation information with respect to the corresponding MBS broadcast session to the MBS UEs. The configuration information may be generated for each MBS broadcast session and included in the MCCH message or the SIB message and may include an IE (e.g., an MBSmeasConfigAppLayerActivated IE) indicating whether the QMC is activated or deactivated. Furthermore, the configuration information may include the information (e.g., an MBSmeasConfigAppLayerPauseReporting IE) indicating QoE measurement result report and restart for controlling the QoE measurement result report in the MBS UE according to a load of the RAN node.

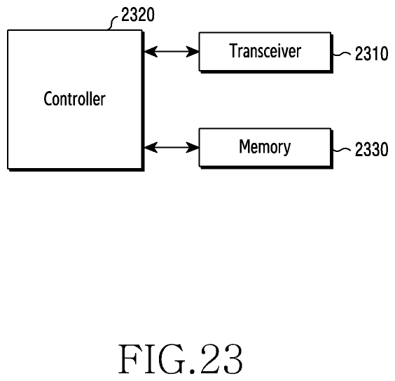

FIG. 23 illustrates a UE according to an embodiment.

Referring to FIG. 23, the UE includes a transceiver 2310, a memory 2330, and a controller (or a processor) 2320. The controller 2320, the transceiver 2310, and the memory 2330 of the UE may operate according to the above-described UE communication method. However, the components of the UE are not limited to the examples described above. For example, the UE may include more or fewer components than the above-described components. In addition, the controller 2320, the transceiver 2310, and the memory 2330 may be implemented in a form of a single chip.

The transceiver 2310 is a collective term of a transmitter of the UE and a receiver of the UE, and may transmit or receive a signal to or from a RAN node. The signal transmitted or received to or from the RAN node may include control information and data. To this end, the transceiver 2310 may include an RF transmitter configured to up-convert and amplify the frequency of the transmitted signal, an RF receiver configured to amplify the received signal with low noise and down-convert the frequency, etc. This is merely an example of the transceiver 2310, and the components of the transceiver 2310 are not limited to the RF transmitter and RF receiver.

Furthermore, the transceiver 2310 may include a wired or wireless transceiver and include various components for transmitting or receiving a signal. In addition, the transceiver 2310 may receive a signal through a wireless channel, output the signal to the processor 2330 and transmit a signal output from the processor 2330 through a wireless channel. In addition, the transceiver 2310 may receive a communication signal, output the signal to the processor 2320, and transmit the signal output from the processor 2320 to the RAN node or a network entity through a wired or wireless channel.

The memory 2330 may store programs and data necessary for the operation of the UE. In addition, the memory 2330 may store control information or data included in signals obtained by the UE. The memory 2330 may include a storage medium such as a read only memory (ROM), a random access memory (RAM), a hard disk, a compact disc (CD)-ROM, and a digital versatile disc (DVD), or a combination of storage media.

The controller 2320 may control a series of processes so that the UE operates according to the above-described embodiments of the disclosure. The controller 2320 may include one or more processors. For example, the controller 2320 may include a communication processor (CP) for performing control for communication and an application processor (AP) for controlling a higher layer, such as an application program.

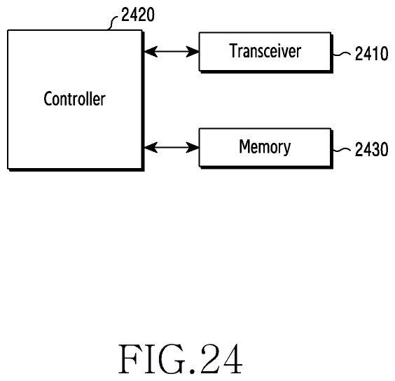

FIG. 24 illustrates a BS (or, a RAN node) according to an embodiment.

Referring to FIG. 24, the RAN node of the disclosure may include a transceiver 2410, a memory 2430, and a controller (or a processor) 2420. The processor 2420, the transceiver 2410, and the memory 2430 of the RAN node may operate according to the above-described RAN node communication method. However, the components of the RAN node are not limited to the examples described above. For example, the RAN node may include more or fewer components than the above-described components.

According to an embodiment, the RAN node may be implemented by separating the entire function into a CU and a DU, and in this case, the CU and the DU may independently perform a portion of functions performed by the RAN node. In addition, the controller 2420, the transceiver 2410, and the memory 2430 may be implemented in a form of a single chip.

The transceiver 2410 is a collective term of a transmitter of the RAN node and a receiver of the RAN node, and may transmit or receive a signal to or from a UE and/or network entity. Here, the signal transmitted or received may include control information and data. To this end, the transceiver 2410 may include an RF transmitter configured to up-convert and amplify the frequency of the transmitted signal, an RF receiver configured to amplify the received signal with low noise and down-convert the frequency, etc. This is merely an example of the transceiver 2410, and the components of the transceiver 2410 are not limited to the RF transmitter and RF receiver. The transceiver 2410 may include a wired or wireless transceiver and include various components for transmitting or receiving a signal.

In addition, the transceiver 2410 may receive a signal through a communication channel (e.g., a wireless channel), output the signal to the controller 2420 and transmit a signal output from the controller 2420 through a communication channel. In addition, the transceiver 2410 may receive a communication signal, output the signal to the processor and transmit the signal output from the processor to the RAN node or a network entity through a wired or wireless channel.

The memory 2430 may store programs and data necessary for the operation of the RAN node. In addition, the memory 2430 may store control information or data included in signals obtained by the RAN node. The memory 2430 may include a storage medium such as a ROM, a RAM, a hard disk, a CD-ROM, and a DVD, or a combination of storage media.

The controller 2420 may control a series of processes so that the RAN node operates according to the above-described embodiments of the disclosure. The controller 2420 may include one or more processors. The methods according to the embodiments disclosed in the claims or the disclosure may be implemented in hardware, software, or a combination of hardware and software.

According to the disclosure, QoE measurement/report/collection procedure of an application related to an MBS broadcast service may be performed smoothly, and thus efficient support of the MBS broadcast service becomes possible.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a RAM and a flash memory, a ROM, an electrically erasable programmable ROM (EEPROM), a magnetic disc storage device, a CD-ROM, DVDs, or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Furthermore, all or a part of a specific embodiment may be employed in combination with all or a part of one or more other embodiments and, of course, these combinations fall within the scope of embodiments in the disclosure.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof

What is claimed is:

1. A method performed by a terminal in a wireless communication system, the method comprising:
receiving, from a base station while the terminal is in a radio resource control (RRC) idle state, information on an application layer measurement configuration associated with a multicast and broadcast service (MBS) broadcast session, wherein the application layer measurement configuration includes a quality of experience (QoE) measurement configuration and a QoE report configuration;
performing a QoE measurement for the MBS broadcast session based on the QoE measurement configuration; and
transmitting, to the base station, a result of the QoE measurement for the MBS broadcast session based on the QoE report configuration.

2. The method of claim 1,
wherein the information on the application layer measurement configuration is received via a system information block 20 (SIB20) including a multicast control channel (MCCH) configuration, or
wherein the information on the application layer measurement configuration is received via an MCCH including an MBS configuration.

3. The method of claim 1,
wherein the information on the application layer measurement configuration includes at least one application layer measurement configuration identifier, and
wherein the QoE measurement is performed for each of the at least one application layer measurement configuration identifier.

4. The method of claim 1,
wherein the QoE measurement is performed based on information indicating whether the QoE measurement is required or not for the MBS broadcast session.

5. The method of claim 1,
wherein the result of the QoE measurement for the MBS broadcast session is transmitted to the base station while the terminal is in an RRC connected state.

6. A method performed by a base station in a wireless communication system, the method comprising:
transmitting, to a terminal in a radio resource control (RRC) idle state, information on an application layer measurement configuration associated with a multicast and broadcast service (MBS) broadcast session, wherein the application layer measurement configuration includes a quality of experience (QoE) measurement configuration and a QoE report configuration; and
receiving, from the terminal, a result of a QoE measurement for the MBS broadcast session based on the QoE report configuration, wherein the QoE measurement is based on the QoE measurement configuration.

7. The method of claim 6,
wherein the information on the application layer measurement configuration is transmitted via a system information block 20 (SIB20) including a multicast control channel (MCCH) configuration, or
wherein the information on the application layer measurement configuration is transmitted via an MCCH including an MBS configuration, and
wherein the information on the application layer measurement configuration is received from a core network, when the MBS broadcast session is setup or modified by the core network.

8. The method of claim 6,
wherein the information on the application layer measurement configuration includes at least one application layer measurement configuration identifier, and
wherein the QoE measurement is performed for each of the at least one application layer measurement configuration identifier.

9. The method of claim 6,
wherein the QoE measurement is performed based on information indicating whether the QoE measurement is required or not for the MBS broadcast session.

10. The method of claim 6,
wherein the result of the QoE measurement for the MBS broadcast session is received from the terminal in an RRC connected state.

11. A terminal in a wireless communication system, the terminal comprising:
a transceiver; and
a controller coupled with the transceiver and configured to:
receive, from a base station while the terminal is in a radio resource control (RRC) idle state, information on an application layer measurement configuration associated with a multicast and broadcast service (MBS) broadcast session, wherein the application layer measurement configuration includes a quality of experience (QoE) measurement configuration and a QoE report configuration,
perform a QoE measurement for the MBS broadcast session based on the QoE measurement configuration, and
transmit, to the base station, a result of the QoE measurement for the MBS broadcast session based on the QoE report configuration.

12. The terminal of claim 11,
wherein the information on the application layer measurement configuration is received via a system information block 20 (SIB20) including a multicast control channel (MCCH) configuration, or
wherein the information on the application layer measurement configuration is received via an MCCH including an MBS configuration.

13. The terminal of claim 11,
wherein the information on the application layer measurement configuration includes at least one application layer measurement configuration identifier, and
wherein the QoE measurement is performed for each of the at least one application layer measurement configuration identifier.

14. The terminal of claim 11,
wherein the QoE measurement is performed based on information indicating whether the QoE measurement is required or not for the MBS broadcast session.

15. The terminal of claim 11,
wherein the result of the QoE measurement for the MBS broadcast session is transmitted to the base station while the terminal is in an RRC connected state.

16. A base station in a wireless communication system, the base station comprising:
a transceiver; and
a controller coupled with the transceiver and configured to:
transmit, to a terminal in a radio resource control (RRC) idle state, information on an application layer measurement configuration associated with a multicast and broadcast service (MBS) broadcast session, wherein the application layer measurement configuration includes a quality of experience (QoE) measurement configuration and a QoE report configuration, and
receive, from the terminal, a result of a QoE measurement for the MBS broadcast session based on the QoE report configuration, wherein the QoE measurement is based on the QoE measurement configuration.

17. The base station of claim 16,
wherein the information on the application layer measurement configuration is transmitted via a system information block 20 (SIB20) including a multicast control channel (MCCH) configuration, or
wherein the information on the application layer measurement configuration is transmitted via an MCCH including an MBS configuration, and
wherein the information on the application layer measurement configuration is received from a core network, when the MBS broadcast session is setup or modified by the core network.

18. The base station of claim 16,
wherein the information on the application layer measurement configuration includes at least one application layer measurement configuration identifier, and
wherein the QoE measurement is performed for each of the at least one application layer measurement configuration identifier.

19. The base station of claim 16,
wherein the QoE measurement is performed based on information indicating whether the QoE measurement is required or not for the MBS broadcast session.

20. The base station of claim 16,
wherein the result of the QoE measurement for the MBS broadcast session is received from the terminal in an RRC connected state.
